(19) United States
(12) Patent Application Publication
(10) Pub. No.: US 2021/0096277 A1
(43) Pub. Date: Apr. 1, 2021

(54) Evaluating Production Performance For A Wellbore While Accounting For Subterranean Reservoir Geomechanics And Wellbore Completion

(71) Applicant: CHEVRON U.S.A.INC., San Ramon, CA (US)

(72) Inventors: Karim Shafik ZAKI, Houston, TX (US); Yan LI, Bellaire, TX (US); Yunhui TAN, Katy, TX (US); Ruiting WU, Sugar Land, TX (US); Margaretha Catharina Maria RIJKEN, Houston, TX (US); Amr Said EL-FAYOUMI, Houston, TX (US); Pietro VALSECCHI, Duesseldorf (DE)

(73) Assignee: CHEVRON U.S.A.INC., San Ramon, CA (US)

(21) Appl. No.: 17/033,155

(22) Filed: Sep. 25, 2020

Related U.S. Application Data
(60) Provisional application No. 62/906,836, filed on Sep. 27, 2019.

(51) Int. Cl. G01V 99/00; E21B 47/06; G06F 30/20

(52) U.S. Cl. CPC G01V 99/005; E21B 47/06; G06F 2113/08; E21B 2200/20; G06F 30/20

(57) ABSTRACT

Embodiments of evaluating production performance for a wellbore while accounting for subterranean reservoir geomechanics and wellbore completion are provided. One embodiment includes generating the wellbore model; defining geomechanical properties for the subterranean reservoir in the near wellbore region and the far field region, and completion variables for the wellbore completion; and simulating fluid flow in the near wellbore region, the far field region, and the wellbore completion to evaluate production performance for the wellbore over a period of time. A permeability of the subterranean reservoir and a contact area between the wellbore and the subterranean reservoir are updated during simulation over the period of time. The permeability and the contact area are updated as a function of a change in pressure and the geomechanical properties for the subterranean reservoir in the near wellbore region and the far field region, the completion variables for the wellbore completion, or any combination thereof.

### CROSS REFERENCES TO RELATED APPLICATIONS

This application claims the benefit of priority to U.S. Provisional Application No. 62/906,836, filed Sep. 27, 2019, which is incorporated by reference herein in its entirety.

### STATEMENT REGARDING FEDERALLY SPONSORED RESEARCH OR DEVELOPMENT

Not applicable.

### TECHNICAL FIELD

The present disclosure relates to evaluating production performance for a wellbore.

### BACKGROUND

The hydrocarbon industry recovers hydrocarbons that are trapped in subterranean reservoirs. The hydrocarbons can be recovered by drilling wellbores into the reservoirs and the hydrocarbons are able to flow from the reservoirs into the wellbores and up to the surface. Operation and management of reservoirs typically rely on the production performance of the wellbores to enable better development planning, economic outlook, and decisions such as decisions related to whether or not to drill an additional wellbore (e.g., infill wellbore), decisions related to whether or not to fracture or refracture an area proximate to a wellbore, decisions related to implementation or adjustment of a hydrocarbon recovery process, etc.

There exists a need in the area of evaluating production performance for a wellbore.

### SUMMARY

Embodiments of evaluating production performance for a wellbore while accounting for subterranean reservoir geomechanics and wellbore completion are provided herein

One embodiment of a computer-implemented method of evaluating production performance for a wellbore while accounting for subterranean reservoir geomechanics and wellbore completion comprises: generating a wellbore model defining a subterranean reservoir with a wellbore. The subterranean reservoir comprises a near wellbore region and a far field region that is different than the near wellbore region, and the wellbore comprises a wellbore completion. The embodiment of the method further comprises defining geomechanical properties for the subterranean reservoir in the near wellbore region and the far field region, and completion variables for the wellbore completion. The embodiment of the method further comprises simulating fluid flow in the near wellbore region, the far field region, and the wellbore completion to evaluate production performance for the wellbore over a period of time. A permeability of the subterranean reservoir and a contact area between the wellbore and the subterranean reservoir are updated during simulation over the period of time. The permeability and the contact area are updated as a function of a change in pressure and the geomechanical properties for the subterranean reservoir in the near wellbore region and the far field region, the completion variables for the wellbore completion, or any combination thereof.

One embodiment of a system of evaluating production performance for a wellbore while accounting for subterranean reservoir geomechanics and wellbore completion comprises: a processor; and a memory communicatively connected to the processor, the memory storing computer-executable instructions which, when executed by the processor, cause the processor to perform a method. The method comprises generating a wellbore model defining a subterranean reservoir with a wellbore. The subterranean reservoir comprises a near wellbore region and a far field region that is different than the near wellbore region, and the wellbore comprises a wellbore completion. The method further comprises defining geomechanical properties for the subterranean reservoir in the near wellbore region and the far field region, and completion variables for the wellbore completion. The method further comprises simulating fluid flow in the near wellbore region, the far field region, and the wellbore completion to evaluate production performance for the wellbore over a period of time. A permeability of the subterranean reservoir and a contact area between the wellbore and the subterranean reservoir are updated during simulation over the period of time. The permeability and the contact area are updated as a function of a change in pressure and the geomechanical properties for the subterranean reservoir in the near wellbore region and the far field region, the completion variables for the wellbore completion, or any combination thereof.

One embodiment of a computer readable storage medium having computer-executable instructions stored thereon which, when executed by a processor, cause the processor to perform a method of evaluating production performance for a wellbore while accounting for subterranean reservoir geomechanics and wellbore completion. The method comprises generating a wellbore model defining a subterranean reservoir with a wellbore. The subterranean reservoir comprises a near wellbore region and a far field region that is different than the near wellbore region. The wellbore comprises a wellbore completion. The method comprises defining geomechanical properties for the subterranean reservoir in the near wellbore region and the far field region, and completion variables for the wellbore completion. The method comprises simulating fluid flow in the near wellbore region, the far field region, and the wellbore completion to evaluate production performance for the wellbore over a period of time. A permeability of the subterranean reservoir and a contact area between the wellbore and the subterranean reservoir are updated during simulation over the period of time. The permeability and the contact area are updated as a function of a change in pressure and the geomechanical properties for the subterranean reservoir in the near wellbore region and the far field region, the completion variables for the wellbore completion, or any combination thereof.

### DESCRIPTION OF THE DRAWINGS

Various figures in the accompanying documentation illustrate various steps and results of embodiments consistent with the principles of the present invention.

FIG. 1 is a system diagram illustrating one embodiment of a system of evaluating production performance for a wellbore while accounting for subterranean reservoir geomechanics and wellbore completion.

FIG. 2 is a flowchart illustrating one embodiment of a method of evaluating production performance for a wellbore while accounting for subterranean reservoir geomechanics and wellbore completion.

FIGS. 3A, 3B, and 3C are diagrams illustrating various embodiments of wellbores, near wellbore regions, and far field regions.

FIG. 4 is a diagram illustrating various damage mechanisms.

FIG. 5 is a diagram illustrating one embodiment of a CHFP completion highlighting fracture plane perforations and off-plane perforations.

FIGS. 6A, 6B, 6C, and 6D illustrate simulation results showing the evolution of the damage zone due to fines migration in a gravel packed well. FIG. 6A illustrates 0.2 day, FIG. 6B illustrates 1 day, FIG. 6C illustrates 5 days, and FIG. 6D illustrates 61 days. The damage radius is 7.1 inches in FIG. 6B, the damage radius is 12.5 inches in FIG. 6C, the damage radius is 23.3 inches in FIG. 6D. The color bar is shown in the upper left of in FIG. 6A, with lower numbers indicating lower permeability multiplier (PMULT) values. FIG. 6E illustrates one example of a permeability reduction trend of extended fines migration tests based on laboratory results.

FIG. 7 is a diagram representing flow into the fracture from the formation and along the fracture.

FIG. 8 is a diagram illustrating geometry for a near wellbore model, considering perforations, fracture and various damage zones.

FIGS. 9A, 9B, 9C, 9D, 9E, 9F, 9G, and 9H illustrating embodiments of PI decline prediction workflow model inputs.

FIG. 10 is a diagram illustrating one embodiment of a workflow.

FIGS. 11A, 11B. 11C, and 11D are diagrams illustrating embodiments of PI decline prediction workflow model deliverables.

FIG. 12 is a diagram illustrating an embodiment of a history match and production forecast comparison for the model.

FIG. 13 is a diagram illustrating an embodiment of a history match with stimulation event implementation.

FIG. 14 is a diagram illustrating an embodiment of field life cycle periods.

FIG. 15 is a diagram illustrating an embodiment of a PI tornado chart for Period 1.

FIG. 16 is a diagram illustrating an embodiment of a normalized PI tornado chart for Period 2.

FIG. 17 is a diagram illustrating an embodiment of a normalized PI tornado chart for Period 3.

FIGS. 18A and 18B are diagrams illustrating a top view of an embodiment of a sector model with detailed well geometry. FIG. 18A is the top view of the whole sector model. The model size depends on drainage region of the reservoir. FIG. 18B is a close-up view illustrating the wellbore details.

FIGS. 19A, 19B, 19C, and 19D are diagrams illustrating an embodiment of a cased hole fracpack model with different damage zones near the well, perforation, and fracture. FIG. 19A shows the damage regions around the wellbore, FIG. 19B shows a perforation tunnel and perforation face damage zones, FIG. 19C shows various fracture lengths, and FIG. 19D shows the fracture face damage zone.

FIG. 20 is a diagram illustrating an embodiment of a pressure drop and velocity cross perforation tunnels.

FIG. 21 is a flow chart illustrating an embodiment of a PI decline prediction workflow.

FIG. 22 is a diagram illustrating an embodiment of a DOE matrix for a cased hold fracpack well.

FIG. 23 is a diagram illustrating an embodiment of a history match workflow.

FIG. 24 is a diagram illustrating an embodiment of a tornado plot of parameters showing impact on production rate.

FIG. 25 is a diagram illustrating an embodiment of a decision tree for a new well.

FIG. 26 is a diagram illustrating an embodiment of a history matched PI.

FIGS. 27A, 27B, 27C, and 27D is a diagram illustrating an embodiment of a PI prediction using a history matched model.

FIG. 28 is a diagram illustrating an embodiment of a comparison of production data result of a history matched reservoir model, and result of a model using PI proxy.

Reference will now be made in detail to various embodiments, where like reference numerals designate corresponding parts throughout the several views. In the following detailed description, numerous specific details are set forth in order to provide a thorough understanding of the present disclosure and the embodiments described herein. However, embodiments described herein may be practiced without these specific details. In other instances, well-known methods, procedures, components, and mechanical apparatuses have not been described in detail so as not to unnecessarily obscure aspects of the embodiments.

### DETAILED DESCRIPTION

TERMINOLOGY: The following terms will be used throughout the specification and will have the following meanings unless otherwise indicated.

Formation: Hydrocarbon exploration processes, hydrocarbon recovery (also referred to as hydrocarbon production) processes, or any combination thereof may be performed on a formation. The formation refers to practically any volume under a surface. For example, the formation may be practically any volume under a terrestrial surface (e.g., a land surface), practically any volume under a seafloor, etc. A water column may be above the formation, such as in marine hydrocarbon exploration, in marine hydrocarbon recovery, etc. The formation may be onshore. The formation may be offshore (e.g., with shallow water or deep water above the formation). The formation may include faults, fractures, overburdens, underburdens, salts, salt welds, rocks, sands, sediments, pore space, etc. Indeed, the formation may include practically any geologic point(s) or volume(s) of interest (such as a survey area) in some embodiments.

The formation may include hydrocarbons, such as liquid hydrocarbons (also known as oil or petroleum), gas hydrocarbons (e.g., natural gas), solid hydrocarbons (e.g., asphaltenes or waxes), a combination of hydrocarbons (e.g., a combination of liquid hydrocarbons and gas hydrocarbons) (e.g., a combination of liquid hydrocarbons, gas hydrocarbons, and solid hydrocarbons), etc. Light crude oil, medium oil, heavy crude oil, and extra heavy oil, as defined by the American Petroleum Institute (API) gravity, are examples of hydrocarbons. Examples of hydrocarbons are many, and hydrocarbons may include oil, natural gas, kerogen, bitumen, clathrates (also referred to as hydrates), etc. The hydrocarbons may be discovered by hydrocarbon exploration processes.

The formation may also include at least one wellbore. For example, at least one wellbore may be drilled into the formation in order to confirm the presence of the hydrocarbons. As another example, at least one wellbore may be drilled into the formation in order to recover (also referred to as produce) the hydrocarbons. The hydrocarbons may be recovered from the entire formation or from a portion of the formation. For example, the formation may be divided into one or more hydrocarbon zones, and hydrocarbons may be recovered from each desired hydrocarbon zone. One or more of the hydrocarbon zones may even be shut-in to increase hydrocarbon recovery from a hydrocarbon zone that is not shut-in.

The formation, the hydrocarbons, or any combination thereof may also include non-hydrocarbon items. For example, the non-hydrocarbon items may include connate water, brine, tracers, items used in enhanced oil recovery or other hydrocarbon recovery processes, etc.

In short, each formation may have a variety of characteristics, such as petrophysical rock properties, reservoir fluid properties, reservoir conditions, hydrocarbon properties, or any combination thereof. For example, each formation (or even zone or portion of the formation) may be associated with one or more of: temperature, porosity, salinity, permeability, water composition, mineralogy, hydrocarbon type, hydrocarbon quantity, reservoir location, pressure, etc. Indeed, those of ordinary skill in the art will appreciate that the characteristics are many, including, but not limited to: shale gas, shale oil, tight gas, tight oil, tight carbonate, carbonate, vuggy carbonate, unconventional (e.g., a rock matrix with an average pore size less than 1 micrometer), diatomite, geothermal, mineral, metal, a formation having a permeability in the range of from 0.000001 millidarcy to 25 millidarcy (such as an unconventional formation), a formation having a permeability in the range of from 26 millidarcy to 40,000 millidarcy, etc.

The terms “formation”, “subsurface formation”, “hydrocarbon-bearing formation”, “reservoir”, “subsurface reservoir”, “subsurface region of interest”, “subterranean reservoir”, “subsurface volume of interest”, “subterranean reservoir”, “subterranean formation”, and the like may be used synonymously. The terms “formation”, “subterranean reservoir, “hydrocarbons”, and the like are not limited to any description or configuration described herein.

Wellbore: A wellbore refers to a single hole, usually cylindrical, that is drilled into the formation for hydrocarbon exploration, hydrocarbon recovery, surveillance, or any combination thereof. The wellbore is usually surrounded by the formation and the wellbore may be configured to be in fluidic communication with the formation (e.g., via perforations). The wellbore may also be configured to be in fluidic communication with the surface, such as in fluidic communication with a surface facility that may include oil/gas/water separators, gas compressors, storage tanks, pumps, gauges, sensors, meters, pipelines, etc.

The wellbore may be used for injection (sometimes referred to as an injection wellbore) in some embodiments. The wellbore may be used for production (sometimes referred to as a production wellbore) in some embodiments. The wellbore may be used for a single function, such as only injection, in some embodiments. The wellbore may be used for a plurality of functions, such as production then injection, in some embodiments. The use of the wellbore may also be changed. The wellbore may be drilled amongst existing wellbores, for example, as an infill wellbore. A wellbore may be utilized for injection and a different wellbore may be used for hydrocarbon production, such as in the scenario that hydrocarbons are swept from at least one injection wellbore towards at least one production wellbore and up the at least one production wellbore towards the surface for processing. On the other hand, a single wellbore may be utilized for injection and hydrocarbon production, such as a single wellbore used for generating fractures (e.g., via hydraulic fracturing or other mechanism to generate fractures) and hydrocarbon production. A plurality of wellbores (e.g., tens to hundreds of wellbores) are often used in a field to recover hydrocarbons.

The wellbore may have straight, directional, or a combination of trajectories. For example, the wellbore may be a vertical wellbore, a horizontal wellbore, a multilateral wellbore, an inclined wellbore, a slanted wellbore, etc. The wellbore may include a change in deviation. As an example, the deviation is changing when the wellbore is curving. In a horizontal wellbore, the deviation is changing at the curved section (sometimes referred to as the heel). As used herein, a horizontal section of a wellbore is drilled in a horizontal direction (or substantially horizontal direction). For example, a horizontal section of a wellbore is drilled towards the bedding plane direction. A horizontal section of a wellbore may be, but is not limited to, a horizontal section of a horizontal wellbore. On the other hand, a vertical wellbore is drilled in a vertical direction (or substantially vertical direction). For example, a vertical wellbore is drilled perpendicular (or substantially perpendicular) to the bedding plane direction.

The wellbore may include a plurality of components, such as, but not limited to, a casing, a liner, a tubing string, a heating element, a sensor, a packer, a screen, a gravel pack, artificial lift equipment (e.g., an electric submersible pump (ESP)), etc. The “casing” refers to a steel pipe cemented in place during the wellbore construction process to stabilize the wellbore. The “liner” refers to any string of casing in which the top does not extend to the surface but instead is suspended from inside the previous casing. The “tubing string” or simply “tubing” is made up of a plurality of tubulars (e.g., tubing, tubing joints, pup joints, etc.) connected together. The tubing string is lowered into the casing or the liner for injecting a fluid into the formation, producing a fluid from the formation, or any combination thereof. The casing may be cemented in place, with the cement positioned in the annulus between the formation and the outside of the casing. The wellbore may also include any completion hardware that is not discussed separately. If the wellbore is drilled offshore, the wellbore may include some of the previous components plus other offshore components, such as a riser.

The wellbore may also include equipment to control fluid flow into the wellbore, control fluid flow out of the wellbore, or any combination thereof. For example, each wellbore may include a wellhead, a BOP, chokes, valves, or other control devices. These control devices may be located on the surface, under the surface (e.g., downhole in the wellbore), or any combination thereof. In some embodiments, the same control devices may be used to control fluid flow into and out of the wellbore. In some embodiments, different control devices may be used to control fluid flow into and out of the wellbore. In some embodiments, the rate of flow of fluids through the wellbore may depend on the fluid handling capacities of the surface facility that is in fluidic communication with the wellbore. The control devices may also be utilized to control the pressure profile of the wellbore.

The equipment to be used in controlling fluid flow into and out of the wellbore may be dependent on the wellbore, the formation, the surface facility, etc. However, for simplicity, the term “control apparatus” is meant to represent any wellhead(s), BOP(s), choke(s), valve(s), fluid(s), and other equipment and techniques related to controlling fluid flow into and out of the wellbore.

The wellbore may be drilled into the formation using practically any drilling technique and equipment known in the art, such as geosteering, directional drilling, etc. Drilling the wellbore may include using a tool, such as a drilling tool that includes a drill bit and a drill string. Drilling fluid, such as drilling mud, may be used while drilling in order to cool the drill tool and remove cuttings. Other tools may also be used while drilling or after drilling, such as measurement-while-drilling (MWD) tools, seismic-while-drilling (SWD) tools, wireline tools, logging-while-drilling (LWD) tools, or other downhole tools. After drilling to a predetermined depth, the drill string and the drill bit are removed, and then the casing, the tubing, etc. may be installed according to the design of the wellbore.

The equipment to be used in drilling the wellbore may be dependent on the design of the wellbore, the formation, the hydrocarbons, etc. However, for simplicity, the term “drilling apparatus” is meant to represent any drill bit(s), drill string(s), drilling fluid(s), and other equipment and techniques related to drilling the wellbore.

The term “wellbore” may be used synonymously with the terms “borehole,” “well,” or “well bore.” The term “wellbore” is not limited to any description or configuration described herein.

Hydrocarbon recovery: The hydrocarbons may be recovered (sometimes referred to as produced) from the formation using primary recovery (e.g., by relying on pressure to recover the hydrocarbons), secondary recovery (e.g., by using water injection (also referred to as waterflooding) or natural gas injection to recover hydrocarbons), enhanced oil recovery (EOR), or any combination thereof. Enhanced oil recovery or simply EOR refers to techniques for increasing the amount of hydrocarbons that may be extracted from the formation. Enhanced oil recovery may also be referred to as tertiary oil recovery. Secondary recovery is sometimes just referred to as improved oil recovery or enhanced oil recovery. EOR processes include, but are not limited to, for example: (a) miscible gas injection (which includes, for example, carbon dioxide flooding), (b) chemical injection (sometimes referred to as chemical enhanced oil recovery (CEOR) that includes, for example, polymer flooding, alkaline flooding, surfactant flooding, conformance control, as well as combinations thereof such as alkaline-polymer (AP) flooding, surfactant-polymer (SP) flooding, or alkaline-surfactant-polymer (ASP) flooding), (c) microbial injection, (d) thermal recovery (which includes, for example, cyclic steam and steam flooding), or any combination thereof. The hydrocarbons may be recovered from the formation using a fracturing process. For example, a fracturing process may include fracturing using electrodes, fracturing using fluid (oftentimes referred to as hydraulic fracturing), etc. The hydrocarbons may be recovered from the formation using radio frequency (RF) heating. Another hydrocarbon recovery process(s) may also be utilized to recover the hydrocarbons. Furthermore, those of ordinary skill in the art will appreciate that one hydrocarbon recovery process may also be used in combination with at least one other recovery process or subsequent to at least one other recovery process. Moreover, hydrocarbon recovery processes may also include other treatments. This is not an exhaustive list of hydrocarbon recovery processes.

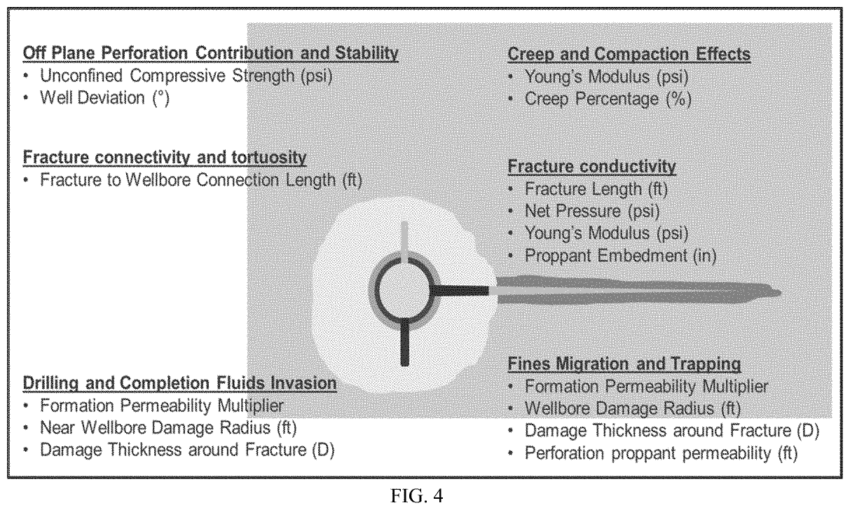

Simulator: The term “simulator” refers to computer software for modeling geophysical systems and processes including porous flow, elastic-plastic deformation of porous solids, transport and deposition. One example of a simulator is the in-house simulator, GMRS™ (Geomechanical Reservoir Simulator). GMRS can model coupled flow and geomechanics, an explicit wellbore, permeability and porosity damages, turbulent flow, etc. All damage mechanisms illustrated in FIG. 4 can be represented in the GMRS model. The model is linked with a Chevron's in-house optimization tool, which has automatic workflow for history matching and uncertainty analysis making the history match and prediction more efficient. However, commercially available simulators and/or optimization tools may be utilized in some embodiments. For example, a commercially available geomechanical simulator or a simulator capable of simulating geomechanics and flow may be utilized. For example, a commercially available tool, such as spreadsheet software, may be used for DOE to find a solution surface for history matching.

Many different scenarios can be modeled in a simulator to generate accurate field performance or production forecasts to help make investment or operational decisions. For example, the simulator may be utilized to simulate performance of a fractured well, simulate performance of an open hole gravel pack, simulate performance of a standalone screen, simulate performance of a cased and perforated completion, etc.

Near wellbore region/Far field region: The term “near wellbore region” includes a wellbore, completions corresponding to the wellbore (e.g., casing, cement, perforations, gravel pack, sand pack, screen, etc.), a fluid invasion damage zone corresponding to the wellbore, any fractures corresponding to the wellbore, and a portion of the subterranean reservoir proximate to the wellbore. Test A can be utilized to identify the near wellbore region for a particular wellbore. Test A includes measuring wellbore pressure against a 1 hour shut-in, and therefore, the near wellbore region in the model will be the distance that a transient pressure wave would move through the subterranean reservoir to the wellbore in 1 hour.

For example, the near wellbore region can be represented as a circle that encompasses generated fractures corresponding to the particular wellbore. In some embodiments, the near wellbore region has a radius that is less than 2000 feet (e.g., less than 1900 feet, less than 1800 feet, less than 1700 feet, less than 1600 feet, less than 1500 feet, less than 1400 feet, less than 1300 feet, less than 1200 feet, less than 1100 feet, less than 1000 feet, less than 900 feet, less than 800 feet, less than 700 feet, less than 600 feet, less than 500 feet, less than 400 feet, less than 300 feet, less than 200 feet, less than 100 feet, less than 75 feet, less than 50 feet, or less than 25 feet). In some embodiments, the near wellbore region has a radius of at least 20 feet (e.g., at least 25 feet, at least 50 feet, at least 75 feet, at least 100 feet, at least 200 feet, at least 300 feet, at least 400 feet, at least 500 feet, at least 600 feet, at least 700 feet, at least 800 feet, at least 900 feet, at least 1000 feet, at least 1100 feet, at least 1200 feet, at least 1300 feet, at least 1400 feet, at least 1500 feet, at least 1600 feet, at least 1700 feet, at least 1800 feet, or at least 1900 feet). The near wellbore region can have a radius ranging from any of the minimum values described above to any of the maximum values described above. For example, in some embodiments, the near wellbore region can have a radius of from 20 feet to 2000 feet (e.g., of from 20 feet to 200 feet, of from 20 feet to 500 feet, of from 100 feet to 500 feet, of from 1500 feet to 2000 feet, or of from 100 feet to 2000 feet).

In some embodiments, the near wellbore region has a radius of about 200 feet. In one embodiment, the near wellbore region has a radius of about 300 feet. In one embodiment, the near wellbore region has a radius of about 400 feet. In one embodiment, the near wellbore region has a radius of about 500 feet. In one embodiment, for an open hole completion with no fractures, the near wellbore region has a radius of about 200 feet. In one embodiment, for a wellbore with at least one fracture in a tight rock reservoir, the near wellbore region has a radius of about 2000 feet.

The term “far field region” includes the rest of the subterranean reservoir that is not within the near wellbore region. The fair field region may also include one or more other wellbores located in the rest of the subterranean reservoir, as well as (1) completions (e.g., casing, cement, perforations, gravel pack, sand pack, screen, etc.), (2) fluid invasion damage zones, and/or (3) any fractures corresponding to the one or more other wellbore located in the rest of the subterranean reservoir. The near wellbore region and the far field region both impact well productivity. For example, perforation efficiency, fracture connectivity, fracture conductivity, fines migration, permeability of the rock, thermal conductivity, pressure gradient, etc. at the near wellbore region impact well productivity. For example, permeability of the rock, compressibility, pressure gradient, creep, fines migration, etc. at the far field region impact well productivity.

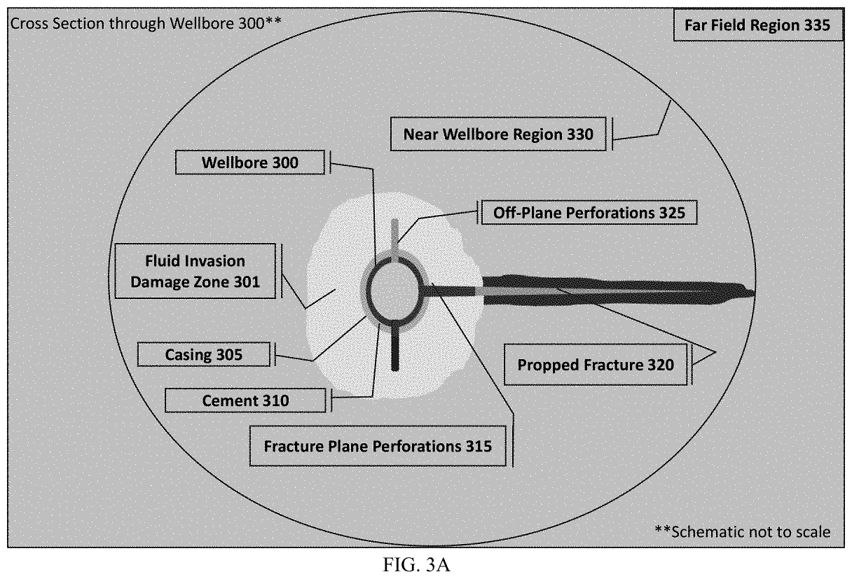

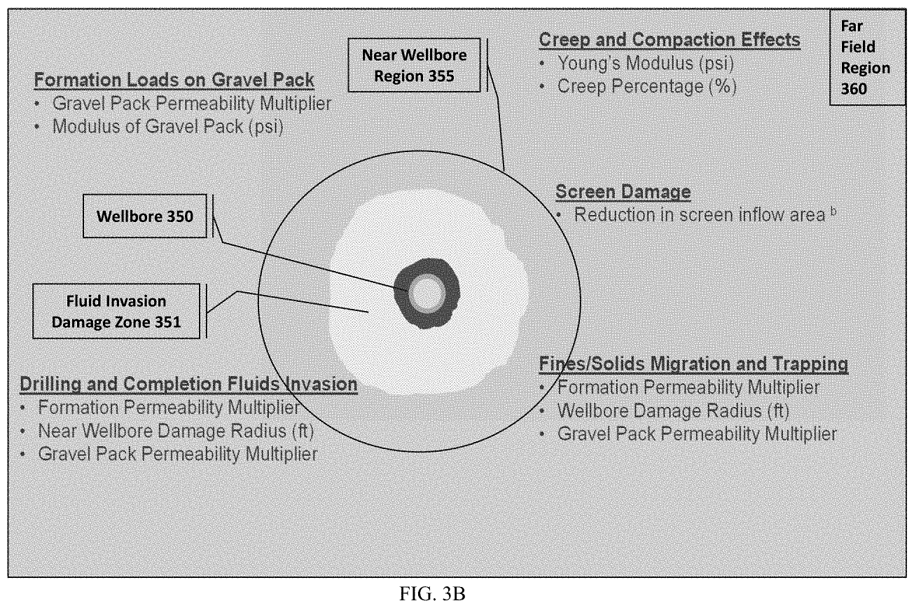

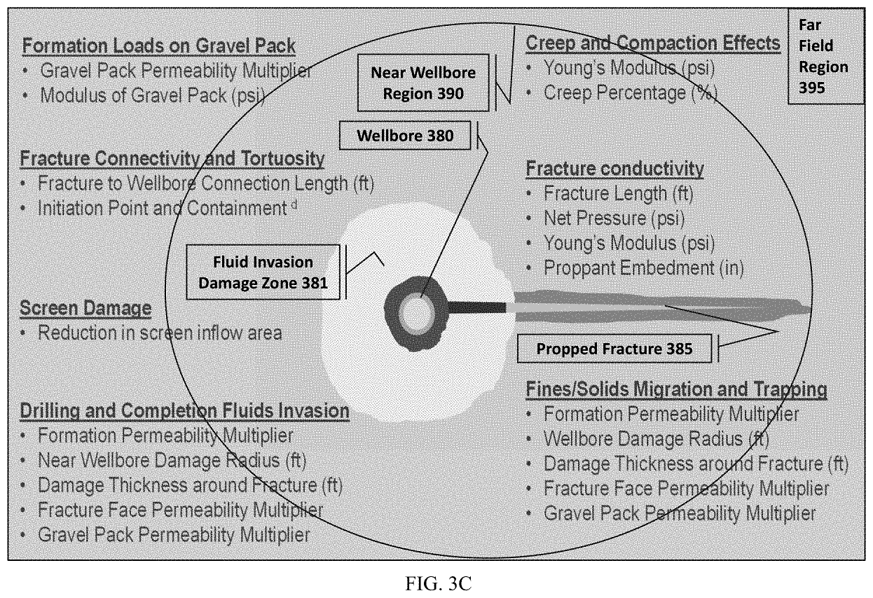

FIGS. 3A, 3B, and 3C are diagrams illustrating various embodiments of wellbores, near wellbore regions, and far field regions. FIG. 3A illustrates an embodiment of a cased hole fracpack wellbore, referred to as wellbore 300. FIG. 3A also illustrates a fluid invasion damage zone 301, casing 305, cement 310, perforations such as fracture plane perforations 315 and off-plane perforations 325, and at least one fracture such as propped fracture 320. FIG. 3A also illustrates a near wellbore region 330 and a far field region 335. The near wellbore region 330 includes the wellbore 300, the fluid invasion damage zone 301, the casing 305, the cement 310, the perforations 315, 325 of the wellbore 300, the at least one fracture illustrated as the propped fracture 320, and the portion of the subterranean reservoir within the near wellbore region 330. Although not shown, the near wellbore region 330 would also include one or more fractures located opposite to the propped fracture 320 (i.e., any fractures on the left side of the wellbore 300 in FIG. 3A).

FIG. 3B illustrates an embodiment of an open hole gravel pack wellbore, referred to as wellbore 350, without fractures. FIG. 3B also illustrates a fluid invasion damage zone 351, a near wellbore region 355, and a far field region 360. The near wellbore region 355 includes the wellbore 350, the fluid invasion damage zone 351, any completions and any perforations of the wellbore 350, and the portion of the subterranean reservoir within the near wellbore region 355.

FIG. 3C illustrates an embodiment of an open hole fracpack wellbore, referred to as wellbore 380, with at least one fracture such as propped fracture 385. FIG. 3C also illustrates a fluid invasion damage zone 381, a near wellbore region 390, and a far field region 395. The near wellbore region 390 includes the wellbore 380, the fluid invasion damage zone 381, any completions and any perforations of the wellbore 380, the at least one fracture illustrated as the propped fracture 385, and the portion of the subterranean reservoir within the near wellbore region 390.

FIGS. 3A, 3B, and 3C are examples and not meant to be limiting. For example, although the near wellbore region can have a circular shape for simplicity, other shapes may be used in some embodiments. Also, the tubing was not mentioned for FIGS. 3A-3C because some embodiments do not simulate the tubing. However, simulations can vary in some embodiments, and some embodiment can simulate the tubing and/or other items as well. Regarding model sizes, larger model sizes may be utilized for lower permeability rock in some embodiments. Alternatively, smaller model sizes may be utilized for larger permeability rock in some embodiments. Thus, model sizes may vary among embodiments.

Other definitions: The term “proximate” is defined as “near”. If item A is proximate to item B, then item A is near item B. For example, in some embodiments, item A may be in contact with item B. For example, in some embodiments, there may be at least one barrier between item A and item B such that item A and item B are near each other, but not in contact with each other. The barrier may be a fluid barrier, a non-fluid barrier (e.g., a structural barrier), or any combination thereof. Both scenarios are contemplated within the meaning of the term “proximate.”

The terms “comprise” (as well as forms, derivatives, or variations thereof, such as “comprising” and “comprises”) and “include” (as well as forms, derivatives, or variations thereof, such as “including” and “includes”) are inclusive (i.e., open-ended) and do not exclude additional elements or steps. For example, the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Accordingly, these terms are intended to not only cover the recited element(s) or step(s), but may also include other elements or steps not expressly recited. Furthermore, as used herein, the use of the terms “a” or “an” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of ±10 percent of the given numeric value provided such a deviation does not alter the end function or result of the value. Therefore, a value of about 1% can be construed to be a range from 0.9% to 1.1%. Furthermore, a range may be construed to include the start and the end of the range. For example, a range of 10% to 20% (i.e., range of 10%-20%) includes 10% and also includes 20%, and includes percentages in between 10% and 20%, unless explicitly stated otherwise herein. Similarly, a range of between 10% and 20% (i.e., range between 10%-20%) includes 10% and also includes 20%, and includes percentages in between 10% and 20%, unless explicitly stated otherwise herein.

The term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein. By way of example, if an item is described herein as including a component of type A, a component of type B, a component of type C, or any combination thereof, it is understood that this phrase describes all of the various individual and collective combinations and permutations of these components. For example, in some embodiments, the item described by this phrase could include only a component of type A. In some embodiments, the item described by this phrase could include only a component of type B. In some embodiments, the item described by this phrase could include only a component of type C. In some embodiments, the item described by this phrase could include a component of type A and a component of type B. In some embodiments, the item described by this phrase could include a component of type A and a component of type C. In some embodiments, the item described by this phrase could include a component of type B and a component of type C. In some embodiments, the item described by this phrase could include a component of type A, a component of type B, and a component of type C. In some embodiments, the item described by this phrase could include two or more components of type A (e.g., A1 and A2). In some embodiments, the item described by this phrase could include two or more components of type B (e.g., B1 and B2). In some embodiments, the item described by this phrase could include two or more components of type C (e.g., C1 and C2). In some embodiments, the item described by this phrase could include two or more of a first component (e.g., two or more components of type A (A1 and A2)), optionally one or more of a second component (e.g., optionally one or more components of type B), and optionally one or more of a third component (e.g., optionally one or more components of type C). In some embodiments, the item described by this phrase could include two or more of a first component (e.g., two or more components of type B (B1 and B2)), optionally one or more of a second component (e.g., optionally one or more components of type A), and optionally one or more of a third component (e.g., optionally one or more components of type C). In some embodiments, the item described by this phrase could include two or more of a first component (e.g., two or more components of type C (C1 and C2)), optionally one or more of a second component (e.g., optionally one or more components of type A), and optionally one or more of a third component (e.g., optionally one or more components of type B).

This written description uses examples to disclose the invention, including the best mode, and also to enable any person skilled in the art to make and use the invention. The patentable scope is defined by the claims, and may include other examples that occur to those skilled in the art. Such other examples are intended to be within the scope of the claims if they have elements that do not differ from the literal language of the claims, or if they include equivalent elements with insubstantial differences from the literal language of the claims.

Unless defined otherwise, all technical and scientific terms used herein have the same meanings as commonly understood by one of skill in the art to which the disclosed invention belongs. All citations referred herein are expressly incorporated by reference.

OVERVIEW: As will be discussed further herein, embodiments are provided herein of evaluating production performance for a wellbore while accounting for subterranean reservoir geomechanics and wellbore completion. One embodiment of a method comprises: generating a wellbore model defining a subterranean reservoir with a wellbore. The subterranean reservoir comprises a near wellbore region and a far field region that is different than the near wellbore region, and the wellbore comprises a wellbore completion. The embodiment of the method further comprises defining geomechanical properties for the subterranean reservoir in the near wellbore region and the far field region, and completion variables for the wellbore completion. The embodiment of the method further comprises simulating fluid flow in the near wellbore region, the far field region, and the wellbore completion to evaluate production performance for the wellbore over a period of time. A permeability of the subterranean reservoir and a contact area between the wellbore and the subterranean reservoir are updated during simulation over the period of time. The permeability and the contact area are updated as a function of a change in pressure and the geomechanical properties for the subterranean reservoir in the near wellbore region and the far field region, the completion variables for the wellbore completion, or any combination thereof.

Advantageously, embodiments consistent with this disclosure may lead to improved accuracy, for example, in modeling and/or simulation. For example, embodiments consistent with this disclosure may improve production forecasting, improve history matching, and/or identify damage mechanisms for a given well or reservoir. Next, these values may be utilized to plan mitigation (e.g., drawdown limits, completion alternative selection, etc.) and/or remediation (e.g., stimulation/acidizing, conformance control, etc.). For example, embodiments consistent with this disclosure may be used for completion design and/or well path design, such as in the area underbalanced perforating.

Faster production declines than initially forecast were Observed in numerous deep-water assets. These wells were completed as Cased Hole Frac-Pack (CHFP) completions with the assumption that rock failure although not initially expected would occur at some point during the production life of the well. Failure of the rock and proppant are significant factors impacting Productivity Index (PI) Decline. The disclosure delves into each of the identified mechanisms and how they impair well productivity.

Seven damage mechanisms were identified as forming the basis for PI degradation: 1) Off-plane perforation contribution and stability (e.g., reduces well to reservoir contact), 2) Fracture connectivity and tortuosity (e.g., may lead to poor well to fracture connectivity), 3) Drilling and completion fluids invasion (e.g., reduces well to reservoir connection quality), 4) Creep and compaction effects (e.g., reduces reservoir permeability), 5) Fracture conductivity (e.g., fracture conductivity loss), 6) Fines migration and trapping (e.g., reduces near wellbore permeability), and 7) Non-Darcy flow effects. These seven damage mechanisms form a significant contribution to the reduction of well performance and specifically Productivity Index (PI). FIG. 4 lists the damage mechanisms and related variables. The mechanisms can be broken down roughly into three major groups. (1) The first group is a reduction in permeability due to a geomechanics response. For these set of mechanisms, the primary driver is the response of the porous media (formation or proppant) to the change in pressure and effective stress. The reduction in pore pressure and the associated increase in effective stress due to production and depletion causes a change in porosity. This reduction in porosity then impacts the permeability of the formation and the conductivity of the proppant in the fracture. (2) The second group is a reduction in permeability due to an increased near wellbore velocity. As flow localizes near the wellbore the velocity increases this can lead to the mobilization and trapping of fines and the prominence of the non-Darcy/Forshheimer flow effect. (3) The third group is a reduction in the inflow area connecting the well to the reservoir. This is predominantly referring to the perforation tunnels and their potential collapse.

A near wellbore production model incorporating the completion, fracture geometry and reservoir is coupled with a geomechanics model to assess each mechanism. A Design of Experiment setup varies the input ranges associated with each of the seven damage mechanisms. Input parameters for the model are risked and rely on ranges from standard and newly developed well and lab tests. The model assesses well performance and driving mechanisms at different points in time within the production life.

Some embodiments disclosed herein primarily focused on high permeability and highly over pressured reservoirs. For the types of wells/fields assessed, the results indicated three phases of decline based on the interaction between the formation properties, the completion components and the operating parameters. The three phases breakdown into: (1) a pre-rock failure stage where declines are relatively small, (2) an ongoing rock failure stage where declines are rapid, and (3) a post failure stage where declines are again moderate. In each of these stages different parameters and damage mechanisms were assessed to be impactful. The workflow was also utilized to match pre and post acidizing treatments. A comparison for varying rock types was included looking at the impact of rock strength and formation permeability on the ranking of the damage mechanisms. The impact of operating parameters such as drawdown can also be assessed showing that increased drawdowns may not always be beneficial to the long-term production of the well.

The disclosure presents the underlying drivers for PI Decline for deep-water assets of a specific attribute set. Through accurate representation of reservoir and completion, the workflow highlights the impact and combined impact of different damage mechanisms. The disclosure also shows a direct link between the mechanical properties (moduli and strength) and boundary conditions (pore pressure and stress) and the well performance and productivity. The workflow provides a methodology by which lab and field tests can be transformed into assessments of future well performance without strictly relying on analogs that may or may not be appropriate.

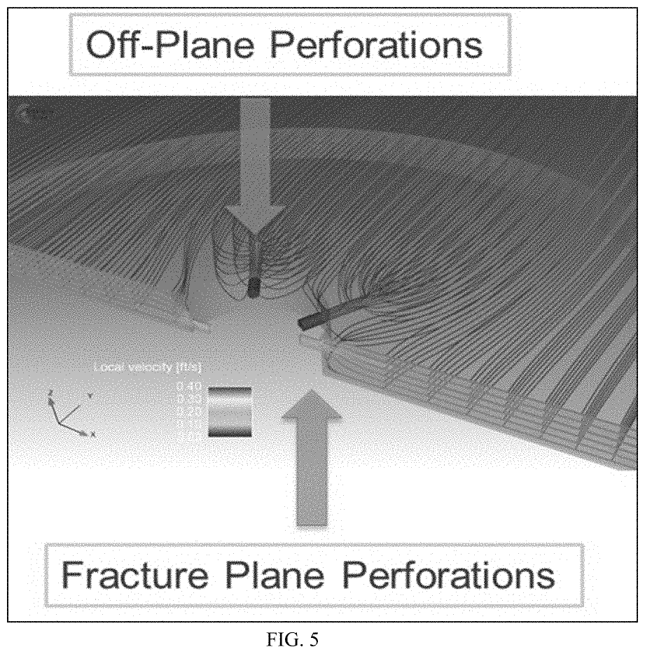

Off plane perforation contribution and stability: Perforations are the conduit between the well and the formation. Reducing the number of perforations increases the pressure drop across the completion for the same flow rate. Sand exclusion completions such as CHFP target weak formations where rock failure is expected at initial or some depleted condition. The intent is to fill as many perforations with proppant as possible. If an unpropped tunnel collapses it becomes filled with low permeability disaggregated particles that inhibit flow. FIG. 5 illustrates the difference between fracture plane perforations, those attached to the fracture, and off-plane perforations, those not attached to the fracture. Due to the nature of the completion type it is generally thought to be difficult to attain a good quality packing of the off-plane perforation tunnels as leak-off from and therefore flow into these tunnels would be significantly less than the fracture plane tunnels. The lack of support caused by the lack of packing proppant in the off-plane tunnels leads to collapse at certain loading conditions. The pressure at which this occurs is referred to as the sanding envelope. In high permeability formations, especially with a damaged lower, than expected permeability proppant, the contribution to the total production rate from these off-plane perforations is quite high. Therefore, when the tunnels collapse the impact on the productivity is substantial. Perforation efficiency and potential reduction with depletion was not previously considered in production forecasting. By incorporating the strength of the rock, the stress directions and the well trajectory the perforation efficiency is predicted as a function of depletion and drawdown. This associated completion pressure drop can then be incorporated into the production forecast.

Fracture connectivity and tortuosity: Fracture propagation is influenced by the stress directions. The intent of fracturing high rate wells that are producing over a short interval is to maximize the number of perforations connected to the fracture by having the fracture run parallel to the well as well as fracturing beyond any near wellbore damage caused by the drilling or completion of the well. The high permeability of the formation typically means that fracture length does not impact the flow profile substantially. The most significant aspect is to create a good connectivity with a thick large width proppant pack near the wellbore. Proppant during the pumping of the FracPack moves with the frac-fluid which will follow the path of least resistance into the perforations connected to the fracture. Hence the likelihood of perforations being propped increases for those connected to the fracture. Well path, perforation interval selection, changes in material properties and operational procedures all impact the number of perforations connected to the fracture. It is a current operational practice to assess deviated well trajectories for fracture connectivity. This is also combined with best practices and operational guidelines developed for increasing well to fracture connectivity. From a production forecast perspective effects of well to fracture connectivity can be incorporated by assessing the well path versus stress directions and incorporating the predicted contact length.

Longitudinal fractures produce a more even inflow into the wellbore at lower velocities and thus are less likely to develop large skin increases or hot spots that lead to productivity decline due to the higher velocities. Transverse fractures localize flow over a given interval creating hot spots as perforation tunnels collapse. These hot spots lead to increased skin.

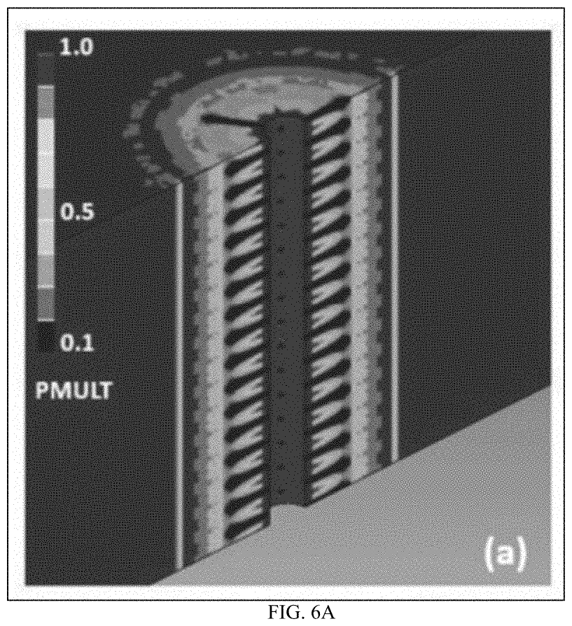

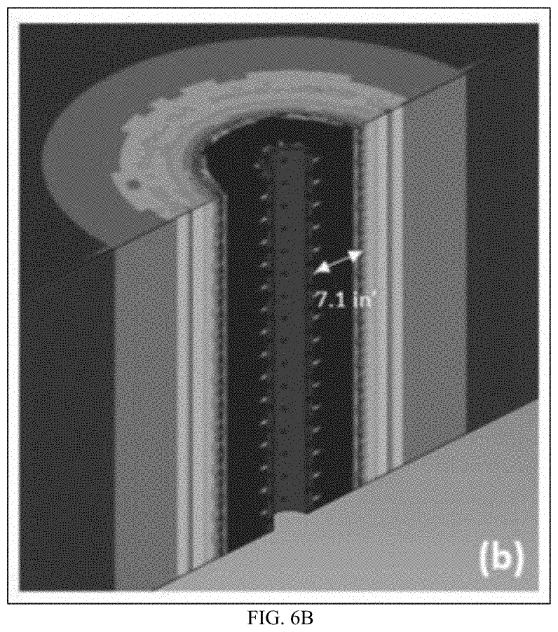

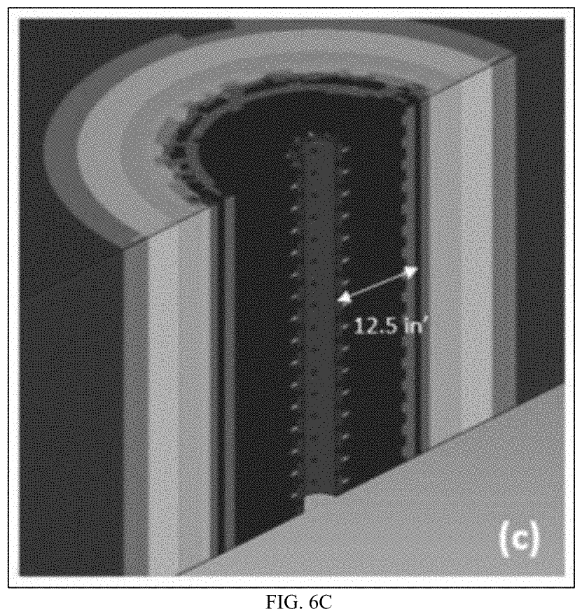

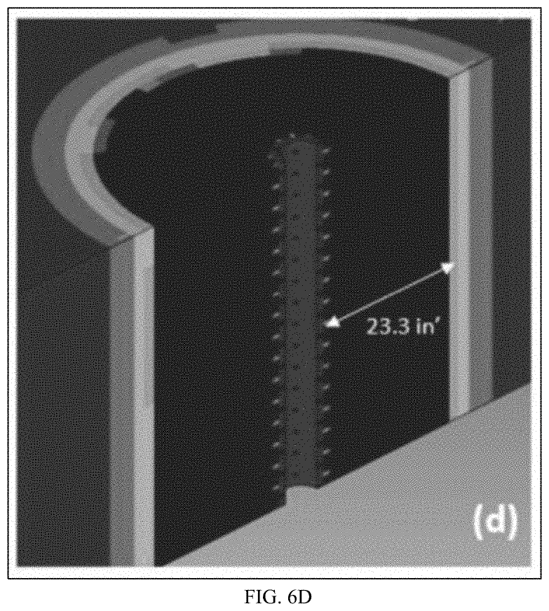

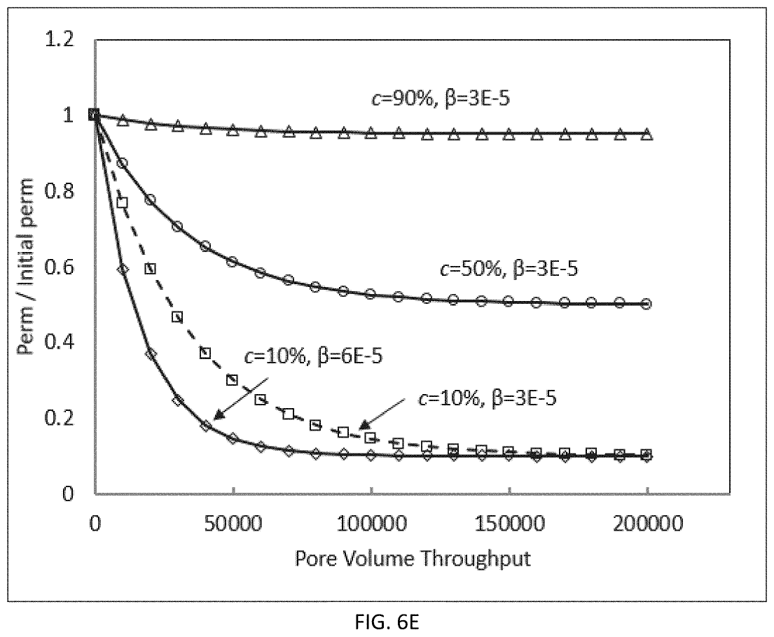

Fines migration and trapping: Loose particles are contained within the pore throat of the formation. At a given critical velocity many of these particles are carried by the fluid phase over short distances and become lodged into smaller pore throats. Typical permeability reduction results, utilizing the updated fines migration test procedure as described in Karazincir, O., Williams, W., & Rijken, P. (2017, Oct. 9). “Prediction of Fines Migration through Core Testing. Society of Petroleum Engineers”, in SPE Annual Technical Conference and Exhibition, San Antonio, Tex., USA, 9-11 Oct. 2017: SPE 187157-MS, which is incorporated by reference. A coupled geomechanics flow simulator was updated to incorporate fines migration damage by utilizing lab derived parameters. Fines migration starts to occur once flow velocity is above critical velocity. To translate the results of the lab tests to the coupled simulator, the permeability reduction was implemented as a function of pore volume through put. Results from this implementation are shown in Tan, Y., Li, Y., Wu, R., Rijken, P., Zaki, K., Karazincir, O., Williams, W., Wang, B. “Modeling of Production Decline Caused by Fines Migration in Deep Water Reservoirs”, in SPE Annual Technical Conference and Exhibition, San Antonio, Tex., USA, 9-11 Oct. 2017: SPE 187263-MS, which is incorporated by reference, and it is evident that the fines migration impact is localized around the wellbore and extends only for a few feet. It is important to note that the longest lab test is around 3 weeks. Permeability redaction beyond that time frame and on a larger scale has some uncertainty. See also FIGS. 6A-6E.

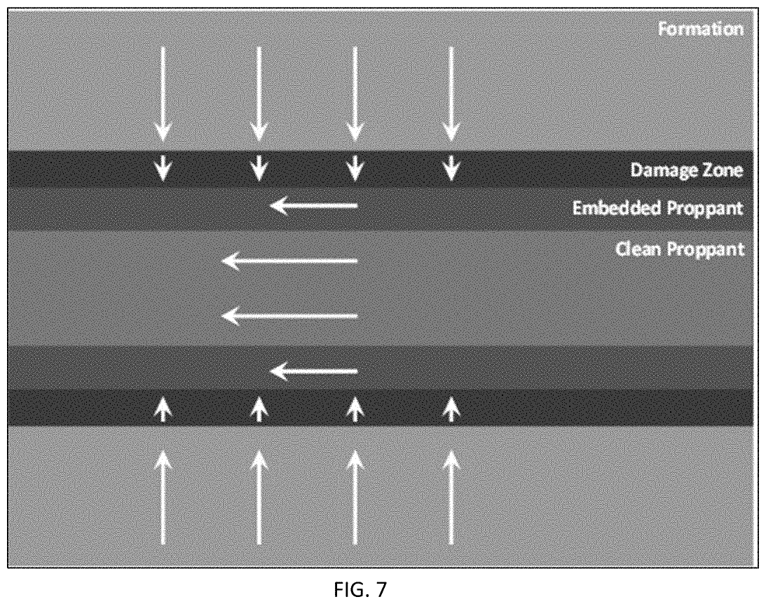

Fracture conductivity: At larger drawdowns and/or depletion levels the closure stress on the proppant is increased. The closure stress is the load imparted on the proppant pack from the formation. The proppant pack permeability is inversely correlated to the closure stress. Permeability versus closure stress is typically measured in lab tests. Lab testing methods typically included testing of proppant between two metal plates and/or between two cores. Two zones have been identified for which tracking of the permeability is desirable: the formation fracture face damage zone and the embedment zone as shown in FIG. 7. These two zones have significantly lower permeability and their permeability reduces with depletion and increased drawdown. Test procedures were developed to assess the permeability of these zones through two-way flow into the core and out the proppant and across the proppant as described in Karazincir, O., Li, Y., Zaki, K., Williams, W., Tan, Y., Wu, R., Rijken, P., Rickards, A. “Measurement of Reduced Permeability at Fracture Face Due to Proppant Embedment and Depletion”, in SPE Annual Technical Conference and Exhibition, Dallas, Tex., USA, 24-26 Sep. 2018: SPE 191653-MS, which is incorporated by reference. Proppant conductivity is typically on the order of hundreds of Darcys. As the proppant is loosely packed in comparison to the formation the reduction in proppant permeability with depletion and/or drawdown is substantial with the proppant expected to lose 50 to 90% of its permeability. Completed wells in deep-water assets can sit for up to six months after completion without production or flowback. During this time the proppant is exposed to non-native fluids of a high pH this causes some weakening of the proppant and formation that it contacts. The weakening leads to a deeper embedment of the proppant into the formation causing it to lose a substantial amount of its permeability.

Creep and compaction: Reservoir depletion causes a reduction in the porosity and permeability of the reservoir. As the reservoir depletes the reduction in permeability reduces the well PI. Porosity reduction is related to depletion through the pore volume compressibility (PVC). Permeability reduction can be measured in the lab and can be inferred from the change in porosity. PVC testing was performed at room temperature and without the application of a long-term hold. This limited the PVC values to elastic and plastic behaviors. Performing the tests utilizing a long-term hold and at reservoir temperature has led to larger values of PVC. Larger values of PVC indicate that for the same level of depletion the reduction in porosity and permeability would be greater than previously anticipated. There is impairment to permeability/transmissibility of adding the time and temperature dependency to the testing methodology. Alternatively, greater PVC values also allude to less depletion for the same produced volume.

Drilling and completion fluid damage: As drilling mud, completion fluid, pre-frac acids and/or frac gel interact with the formation, they cause a geochemical response that alters the material properties of the rock. The properties considered for alteration are the permeability, modulus and strength. A damage zone was considered to exist around the fracture, but the thought had been mainly to fracture past it. Lab experiments were conducted on several samples to assess whether significant changes occurred to the rock properties with aging within a non-native fluid for a period. Experiments proved that the rock properties typically did not change considerably with one or two exceptions. Hydrofluoric acid was not used in the experiments. Utilization of stress caging muds was also found to extend the damage zone created by the drilling mud. This was typically found to have an impact on breakdown pressure but no direct links to PI. The presence of the damage zone however did emphasize the need to have a thick fracture near the wellbore.

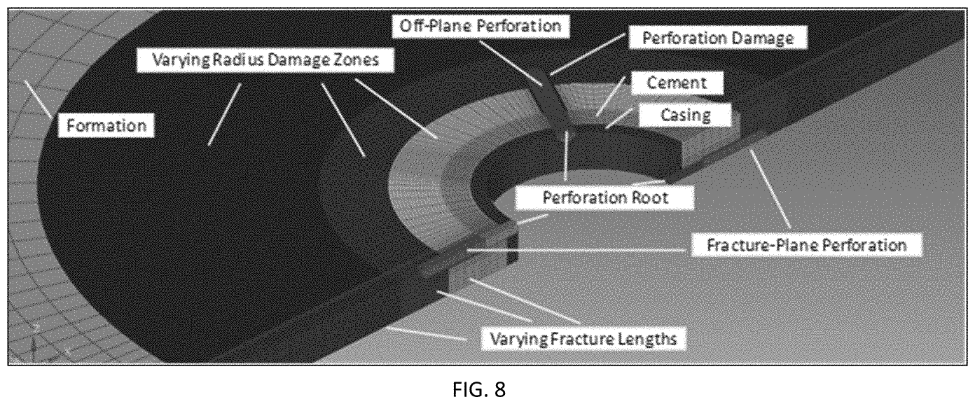

Non-Darcy flow component: Coupled to the above-mentioned damage mechanisms, the Non-Darcy or Forshheimer component is considered within the near wellbore. The detailed description of the near wellbore included in the model, as shown in FIG. 8, allows for a relatively accurate assessment of the velocity around the wellbore.

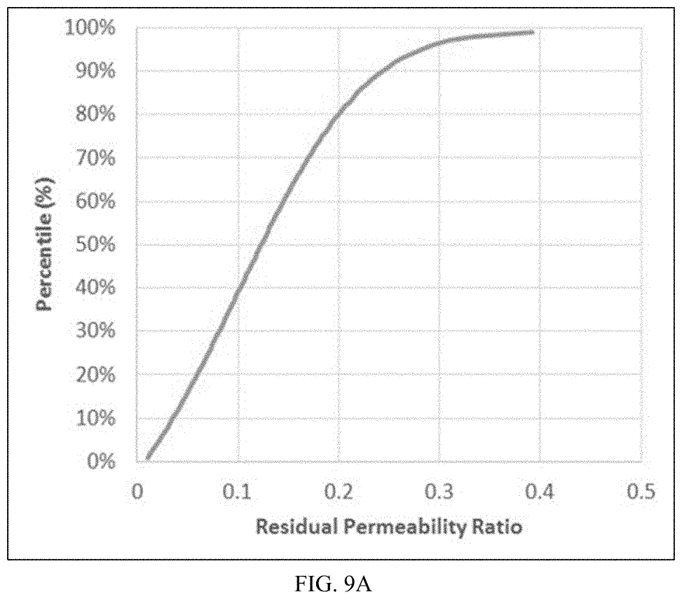

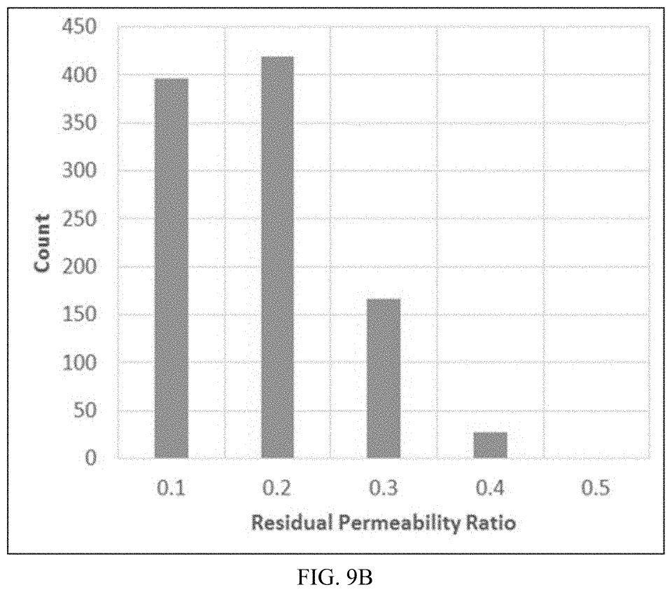

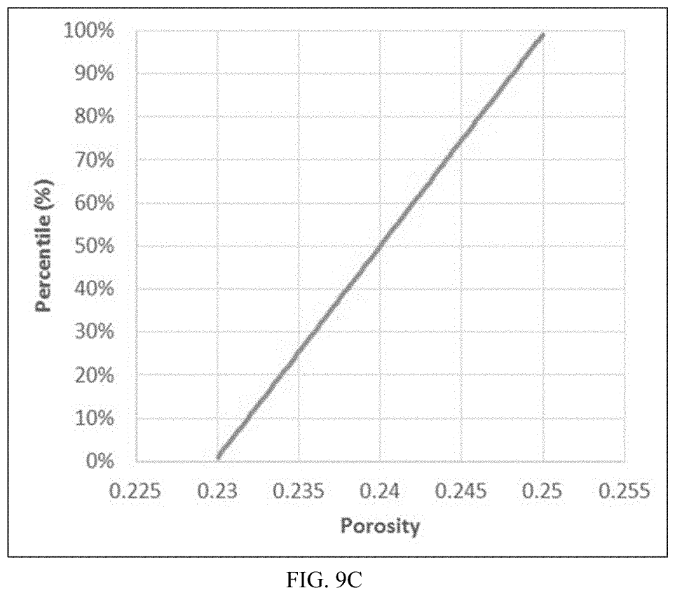

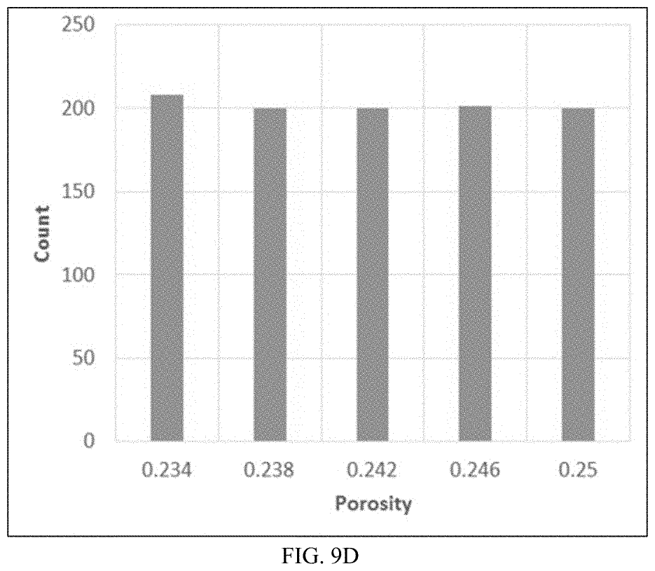

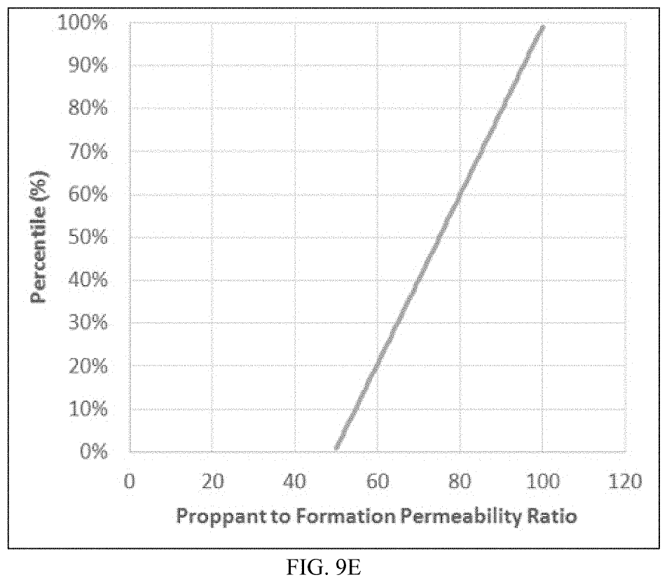

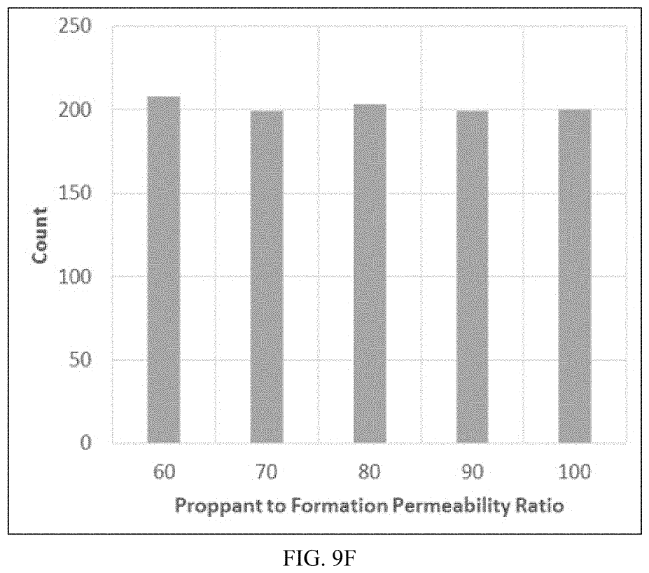

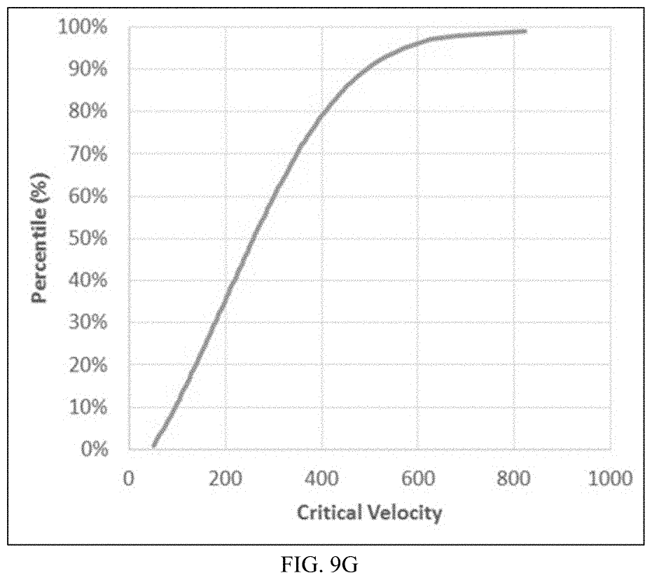

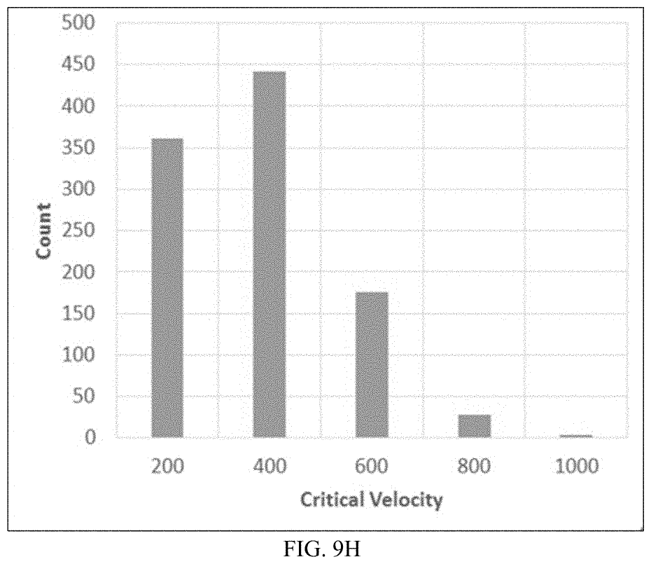

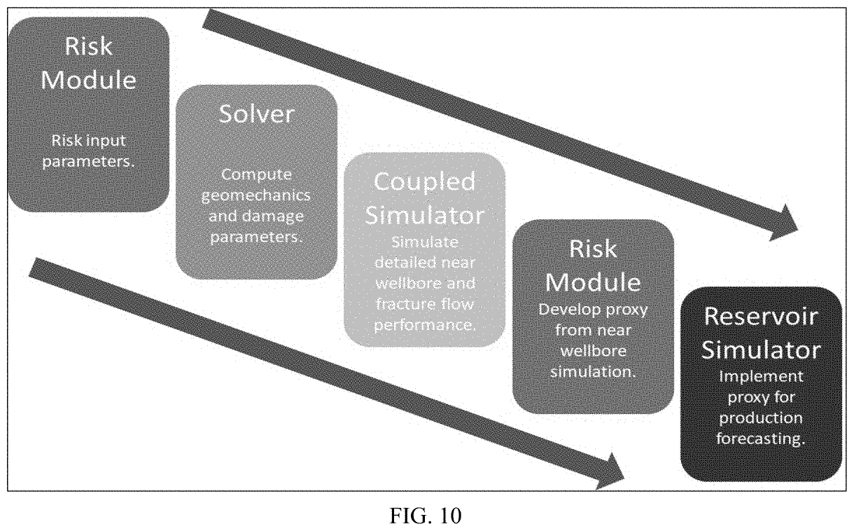

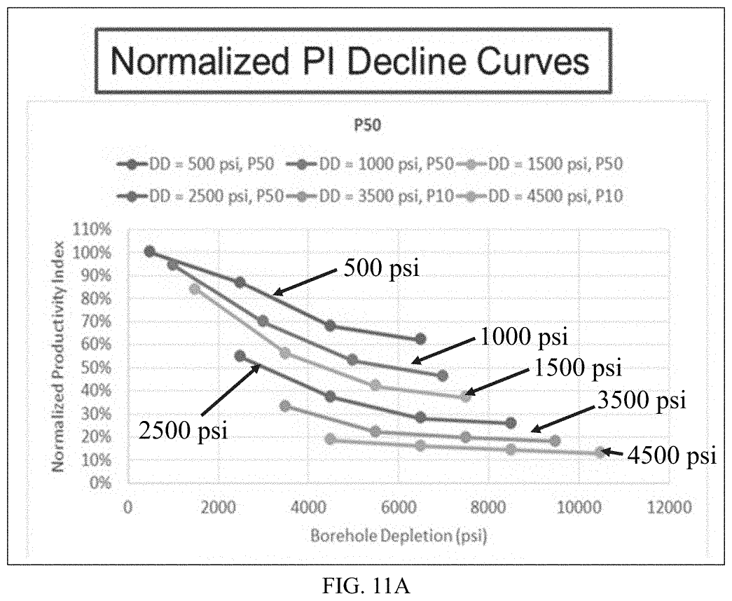

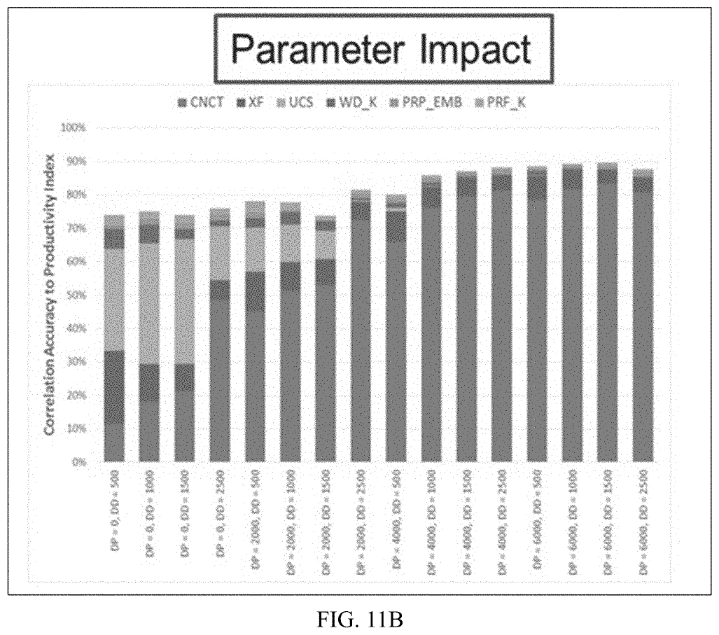

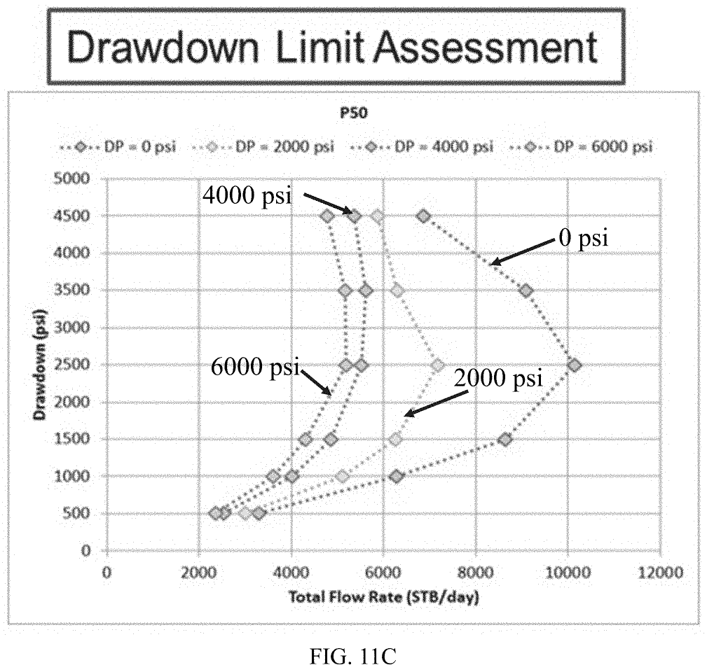

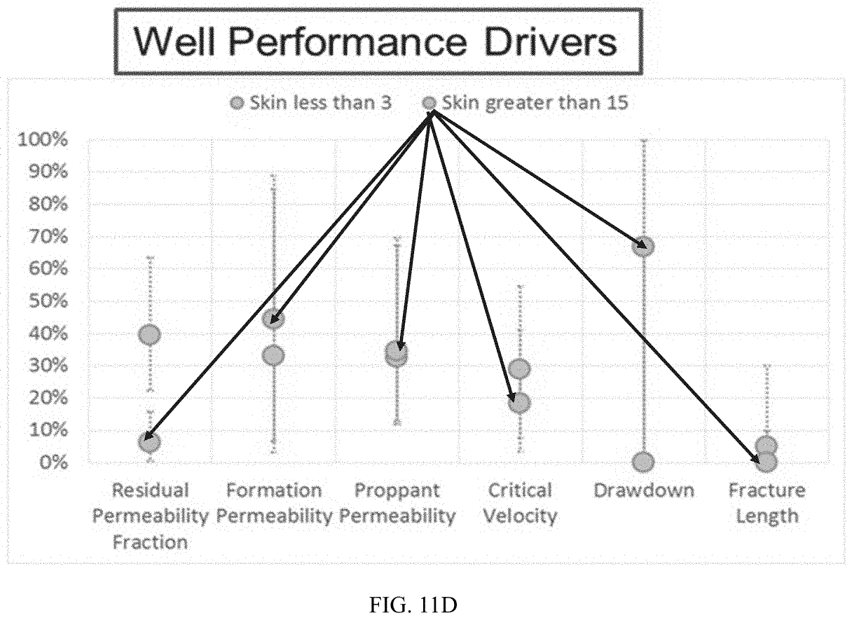

Model Setup: The model utilizes a probabilistic distribution of inputs based on variability and uncertainty in lab results, log data and field tests as well as conventional knowledge and SME inputs as shown in FIGS. 9A-9H. These values are populated into a coupled geomechanics/reservoir simulator to assess the well PI at different depletions, drawdowns and total production volumes across the well life. The inputs to the model are sampled based on a risk module that provides the inputs to the solver and the coupled simulator. The values included in the inputs are typically not included in a reservoir simulator such as mechanical properties (Young's Modulus, Poisson's ratio) and completion variables (fracture length, perforation tunnel diameter). Hence a proxy function, which relates PI to depletion, drawdown, and produced volume, is created to translate the response into the reservoir simulator. The process is outlined in FIG. 10. Alignment and buy-in from key disciplines (production, reservoir, completion and drilling) is desirable to assure that the inputs cover a valid range. The key model deliverables as shown in FIGS. 11A-11D include: (1) PI decline prediction curves that can be utilized in a reservoir simulator as a function of the applied drawdown, the average drainage region pressure, and the cumulative produced volume, (2) Operational guidelines for drawdown limits, optimizing the PI and Recovery over the long term, (3) Identification of the main drivers behind PI Decline for a specific asset and/or (4) Identification of the differentiating parameters and their ranges between potentially poor performing wells and good performing wells.

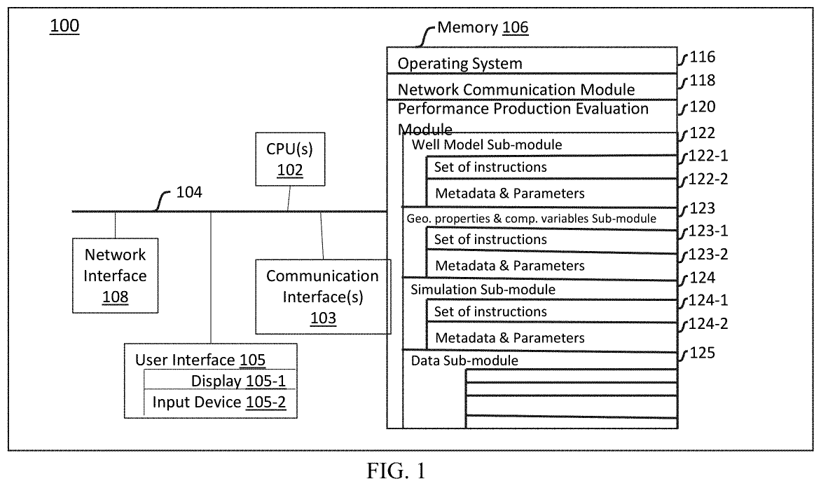

System—FIG. 1 is a block diagram illustrating a geomechanics and flow simulation system of evaluating production performance of a wellbore, such as a system 100, in accordance with some embodiments. While certain specific features are illustrated, those skilled in the art will appreciate from the present disclosure that various other features have not been illustrated for the sake of brevity and so as not to obscure more pertinent aspects of the embodiments disclosed herein.

To that end, the geomechanics and flow simulation system 100 (also known as a simulator) includes one or more processing units (CPUs) 102, one or more network interfaces 108 and/or other communication interfaces 103, memory 106, and one or more communication buses 104 for interconnecting these and various other components. For example, the flow and geomechanics simulation system 100 includes at least one processing units (CPUs) 102 communicatively connected to at least one memory 106 via a communication bus 104. The processing units 102 may be any of a variety of types of programmable circuits capable of executing computer-readable instructions to perform various tasks, such as mathematical and communication (e.g., input/output) tasks. Processing units 102 can contain multiple CPUs (e.g., 2, 4, 6) each containing a single or multiple cores (e.g., 2, 4, 8, 10, 12, 16, 32, 64, etc.). The flow and geomechanics simulation system 100 may comprise a computer, a phone, a tablet, a laptop, a wireless device, a wired device, a plurality of networked devices, etc. In some embodiments, the flow and geomechanics simulation system 100 represents at least one computer. In some embodiments, the flow and geomechanics simulation system 100 represents one computing node in a network cluster or in a cloud computing system.

The flow and geomechanics simulation system 100 also includes a user interface 105 (e.g., a display 105-1 and an input device 105-2). The communication buses 104 may include circuitry (sometimes called a chipset) that interconnects and controls communications between system components. An operator can actively input information and review operations of system 100 using the user interface 105. User interface 105 can be anything by which a person can interact with system 100, which can include, but is not limited to, the input device 105-2 (e.g., a keyboard, mouse, etc.) or the display 105-1.

Memory 106 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 106 may optionally include one or more storage devices remotely located from the CPUs 102. Memory 106, including the non-volatile and volatile memory devices within memory 106, comprises a non-transitory computer readable storage medium and may store simulation models and/or subterranean reservoir information or properties (e.g., permeability, porosity, compressibility, viscosity, saturation, etc. In particular embodiments, the computer readable storage medium comprises at least some tangible devices, and in specific embodiments such computer readable storage medium includes exclusively non-transitory media.

In some embodiments, memory 106 or the non-transitory computer readable storage medium of memory 106 stores the following programs, modules and data structures, or a subset thereof including an operating system 116, a network communication module 118, and a production performance evaluation module 120. The operating system 116 includes procedures for handling various basic system services and for performing hardware dependent tasks. The network communication module 118 facilitates communication with other devices via the communication network interfaces 108 (wired or wireless) and one or more communication networks, such as the Internet, other wide area networks, local area networks, metropolitan area networks, and so on.

In some embodiments, the production performance module evaluation 120 executes the operations of the methods shown in the figures. The production performance evaluation module 120 may include data sub-module 125, which handles and processes the data. The sub-module 125 may also supply data to other sub-modules. For example, the data may be inputted by an operator via the user interface 105, received from one or more sensors, received from one or more system of records, etc.

A wellbore model sub-module 122 contains a set of instructions 122-1 and accepts metadata and parameters 122-2 that generate a wellbore model defining a subterranean reservoir with a wellbore. The subterranean reservoir comprises a near wellbore region and a far field region that is different than the near wellbore region, and the wellbore comprises a wellbore completion. A geomechanical properties and completion variables sub-module 123 contains a set of instructions 123-1 and accepts metadata and parameters 123-2 that define geomechanical properties for the subterranean reservoir in the near wellbore region and the far field region, and completion variables for the wellbore completion. A simulation sub-module 124 contains a set of instructions 124-1 and accepts metadata and parameters 124-2 that simulate fluid flow in the near wellbore region, the far field region, and the wellbore completion to evaluate production performance for the wellbore over a period of time. A permeability of the subterranean reservoir and a contact area between the wellbore and the subterranean reservoir are updated during simulation over the period of time. The permeability and the contact area are updated as a function of a change in pressure and the geomechanical properties for the subterranean reservoir in the near wellbore region and the far field region, the completion variables for the wellbore completion, or any combination thereof.

In some embodiments, evaluating production performance over the period of time includes generating a production forecast, evaluating productivity index (PI) decline for the wellbore, evaluating depletion for the wellbore, evaluating completion quality for the wellbore completion, optimizing a wellbore construction of the wellbore, optimizing the wellbore completion of the wellbore, or any combination thereof. In some embodiments, at least one of these, such as the production forecast, may be output to an operator or to another system(s) via the user interface 105, the network communication module 118, a printer, the display 105-1, a data storage device, any combination thereof, etc.

Although specific operations have been identified for the sub-modules discussed herein, this is not meant to be limiting. Each sub-module may be configured to execute operations identified as being a part of other sub-modules, and may contain other instructions, metadata, and parameters that allow it to execute other operations of use in processing geomechanics and flow simulation data such simulating multiple damage mechanisms in conjunction with each other (e.g., not sequential) and evaluating production performance. For example, any of the sub-modules may optionally be able to generate a display that would be sent to and shown on the user interface display 105-1. In addition, any of the data or processed data products may be transmitted via the communication interface(s) 103 or the network interface 108 and may be stored in memory 106.

Method 200 is, optionally, governed by instructions that are stored in computer memory or a non-transitory computer readable storage medium (e.g., memory 106) and are executed by one or more processors (e.g., processors 102) of one or more computer systems. The computer readable storage medium may include a magnetic or optical disk storage device, solid state storage devices such as flash memory, or other non-volatile memory device or devices. The computer readable instructions stored on the computer readable storage medium may include one or more of: source code, assembly language code, object code, or another instruction format that is interpreted by one or more processors. In various embodiments, some operations in each method may be combined and/or the order of some operations may be changed from the order shown in the figures. For ease of explanation, method 200 is described as being performed by a computer system, although in some embodiments, various operations of method 200 are distributed across separate computer systems.

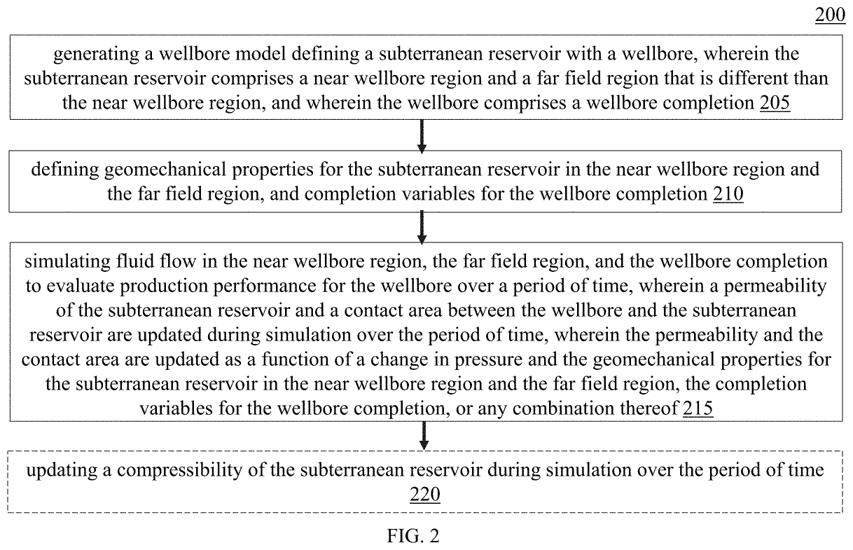

Turning to FIG. 2, this figure illustrates one embodiment of a method of evaluating production performance for a wellbore while accounting for subterranean reservoir geomechanics and wellbore completion, such as a method 200.

At 205, the method 200 includes generating a wellbore model defining a subterranean reservoir with a wellbore. The subterranean reservoir comprises a near wellbore region and a far field region that is different than the near wellbore region. The wellbore comprises a wellbore completion.

In some embodiments, the wellbore model may define a subterranean reservoir with a single wellbore. In some embodiments, the wellbore model may define a subterranean reservoir with a plurality of wellbores.

Furthermore, in some embodiments, the wellbore comprises a single wellbore completion. In some embodiments, a wellbore may comprise a plurality of completions. In some embodiments, one or more completions of a wellbore may be changed. Various wellbore completions may be possible. In some embodiments, the wellbore completion may be confined within the wellbore. For example, an open hole gravel pack completion is confined within the wellbore. As another example, a standalone screen completion is confined within the wellbore. As another example, practically any cased hole completion without fractures in the near wellbore region may be confined within the wellbore. However, in some embodiments, the wellbore completion may be in the wellbore and in the near wellbore region. For example, a cased hole frac pack completion is in the wellbore and in the near wellbore region. As another example, practically any cased hole completion with fractures generated in the near wellbore region may be in the wellbore and the near wellbore region.

In some embodiments, the near wellbore region may be the region proximate to the wellbore. The wellbore completion may be in the near wellbore region in some embodiments, whereas the wellbore completion may not be in the far field region. In some embodiments, the near wellbore region may comprise one or more fractures. In some embodiments, the wellbore model further comprises at least one fracture geometry in the subterranean reservoir in the near wellbore region.

At 210, the method 200 includes defining geomechanical properties for the subterranean reservoir in the near wellbore region and the far field region, and completion variables for the wellbore completion. In some embodiments, the geomechanical properties for the subterranean reservoir comprise Poisson's ratio, Young's Modulus, shear modulus, bulk modulus (or other elastic parameters), formation strength parameter (e.g., unconfined compressive strength, hollow cylinder strength, friction angle, or cohesion), Biot's Constant, post yield behavior (e.g., dilation angle), or any combination thereof. In some embodiments, the completion variables for the wellbore completion comprise a fracture length, a perforation tunnel diameter, or any combination thereof.

At 215, the method 200 includes simulating fluid flow in the near wellbore region, the far field region, and the wellbore completion to evaluate production performance for the wellbore over a period of time. A permeability of the subterranean reservoir and a contact area between the wellbore and the subterranean reservoir are updated during simulation over the period of time. The permeability and the contact area are updated as a function of a change in pressure and the geomechanical properties for the subterranean reservoir in the near wellbore region and the far field region, the completion variables for the wellbore completion, or any combination thereof.

In some embodiments, the contact area between the wellbore and the subterranean reservoir includes the wellbore, the wellbore completion, and the near wellbore region are the contact area. In some embodiments, a change in pressure may be a change in bottomhole pressure in the wellbore, a change in pressure in the near wellbore region, a change in pressure the far field region, or any combination thereof. In some embodiments, the completion variables for the wellbore completion comprise a fracture length, a perforation tunnel diameter, or any combination thereof.

In some embodiments, the permeability and the contact area between the wellbore and the subterranean reservoir are updated based on a change in effective stress in the near wellbore region, the far field region, the completion, or any combination thereof. In some embodiments, the permeability and the contact area between the wellbore and the subterranean reservoir are updated based on a change in a fluid flow velocity in the near wellbore region, the far field region, the completion, or any combination thereof. In some embodiments, the permeability is updated based on a change in the contact area coupling the wellbore to the subterranean reservoir.

In some embodiments, at least two of the following are performed: (i) the permeability and the contact area between the wellbore and the subterranean reservoir are updated based on a change in effective stress in the near wellbore region, the far field region, the completion, or any combination thereof; (ii) the permeability and the contact area between the wellbore and the subterranean reservoir are updated based on a change in a fluid flow velocity in the near wellbore region, the far field region, the completion, or any combination thereof; or (iii) the permeability is updated based on a change in the contact area coupling the wellbore to the subterranean reservoir.

In some embodiments, the permeability and the contact area between the wellbore and the subterranean reservoir are updated based on one or more damage mechanisms in the near wellbore region, the far field region, the completion, or any combination thereof. Regarding the one or more damage mechanisms, in some embodiments, the one or more damage mechanisms comprise fracture connectivity and tortuosity, fracture conductivity, fines migration and trapping, off plane perforation contribution and stability, creep and compaction, drilling and fluid completion damage, non-darcy fluid flow, or any combination thereof. Multiple damage mechanisms are simulated in conjunction with each other (e.g., not sequential) in some embodiments.

In some embodiments, the contact area between the wellbore and the subterranean reservoir is updated based on a fracture geometry in the subterranean reservoir in the near wellbore region, fines migration related parameters, or any combination thereof. In some embodiments, the fines migration related parameters comprise fines damage permeability, proppant damage, fines damage rate, or any combination thereof. In some embodiments, the fracture geometry in the subterranean reservoir comprises a fracture length, fracture plane, a number of perforations connected to the fracture, or any combination thereof.

In some embodiments, evaluating production performance over the period of time further comprises generating a production forecast, evaluating productivity index (PI) decline for the wellbore, evaluating depletion for the wellbore, evaluating completion quality for the wellbore completion, optimizing a wellbore construction of the wellbore, optimizing the wellbore completion of the wellbore, or any combination thereof.

Optionally, at 220, the method 200 includes updating a compressibility of the subterranean reservoir during simulation over the period of time.

Example A: An example, referred to Example A, is provided below. Information about Example A is also found in Zaki, K, Li, Y, Tan, Y, Wu, R, Rijken, P, “Productivity Decline: The Underlying Geomechanics and Contributing Damage Factors”, SPE Annual Technical Conference and Exhibition, Calgary, Alberta, Canada, 30 Sep.-2 Oct. 2019: SPE-196223-MS, which is incorporated by reference.

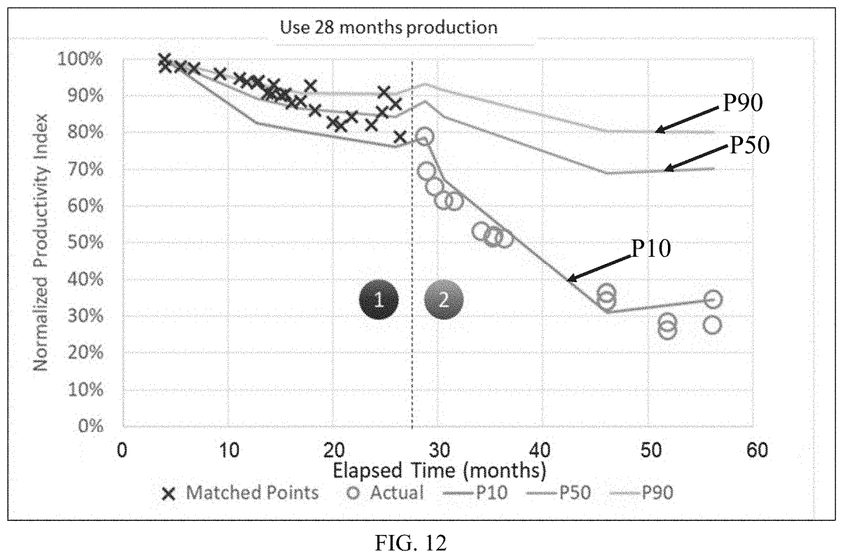

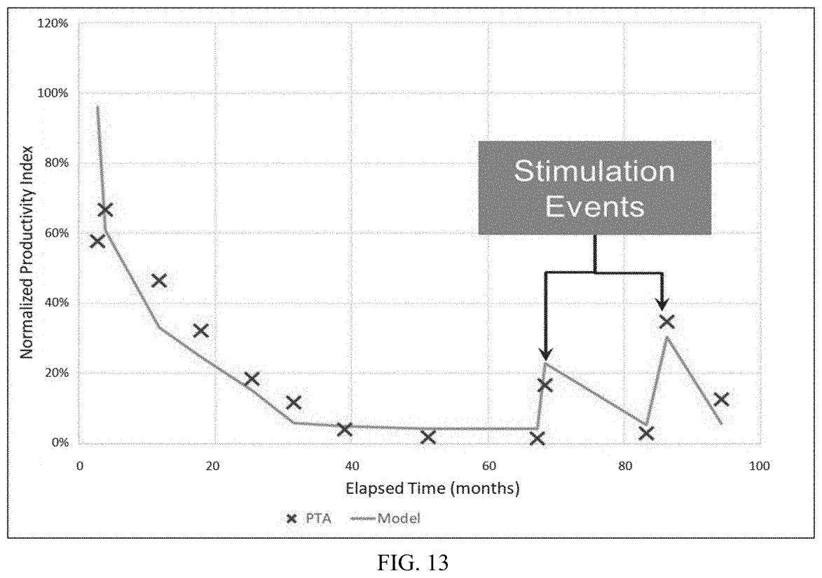

Example A—Model Results: FIG. 12 illustrates a typical result from the workflow of Example A. The productivity index is normalized to a reference value based on the early life well productivity index. In the assessment, the first 28 months of production are utilized to train the model by narrowing the input ranges in such a manner that several history matches are created of the performance. Each match contains a different percentage combination of the previously discussed damage mechanisms. By subsequently extrapolating the potential performance of these scenarios varying production forecasts are created. By extrapolating the performance of the first 28 months from a trend perspective the performance of the well would likely extrapolate in a similar manner to the P50 and P90 trends. However, as actually observed from the data, performance matches the predicted P10 performance where a previously untriggered damage mechanisms creates a sharp decline in the productivity of the well. In this case, this mechanism is the onset of perforation tunnel collapse that is related to the amount of depletion and drawdown encountered at that point in time. FIG. 13 shows a match with a different well that has undergone two acid stimulations at the indicated dates. This stimulation event allows then for a more representative calibration of the model to the historical performance as it targets a specific mechanism, namely fines migration. In this sense a more accurate representation of the damage mechanisms is possible. The model can then also be utilized to assess the impact of future stimulations on the performance of this or other wells in the field.

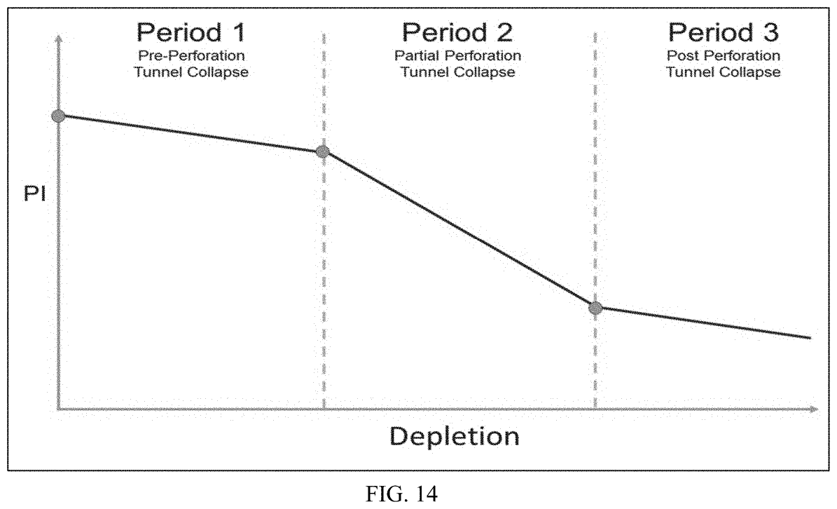

Another product of the tool is the categorization of the relative impact of varying damage mechanisms at different points in time across the well life. For the assessed formation type, namely, high permeability, over pressured and intermediate strength rock three periods of performance were identified. The periods as indicated in FIG. 14 can be categorized as period 1 pre-perforation tunnel collapse, period 2 partial perforation tunnel collapse, and period 3 post perforation tunnel collapse. A tornado chart was developed to represent each of these periods.

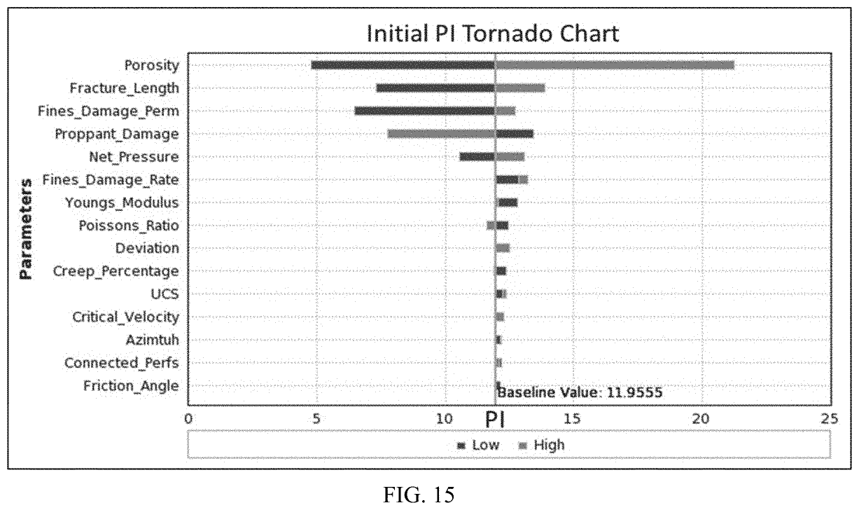

For period 1 (pre-perforation tunnel collapse), the initial productivity is defined by formation properties (porosity and permeability) and fracture characteristics (fracture length and net pressure). For this model, the porosity is directly correlated to the permeability using a fixed poro-perm correlation. This means that rather than the porosity directly controlling the productivity, it is the permeability as a single variable function of the porosity that is causing the increase in productivity. The decline rate during this period is typically gentle and defined by fines migration related parameters (Fines Damage Permeability, Proppant Damage and Fines Damage Rate). The period ends at the point at which the total borehole depletion causes the perforation tunnels to start to collapse. This is defined by the formation strength parameter (UCS) and the elastic parameters that govern the relationship between pressure and the total and effective stress (Poisson's Ratio, Biot's Constant and Young's Modulus). A representation of the order of these variables and their relative impact can be seen in FIG. 15.

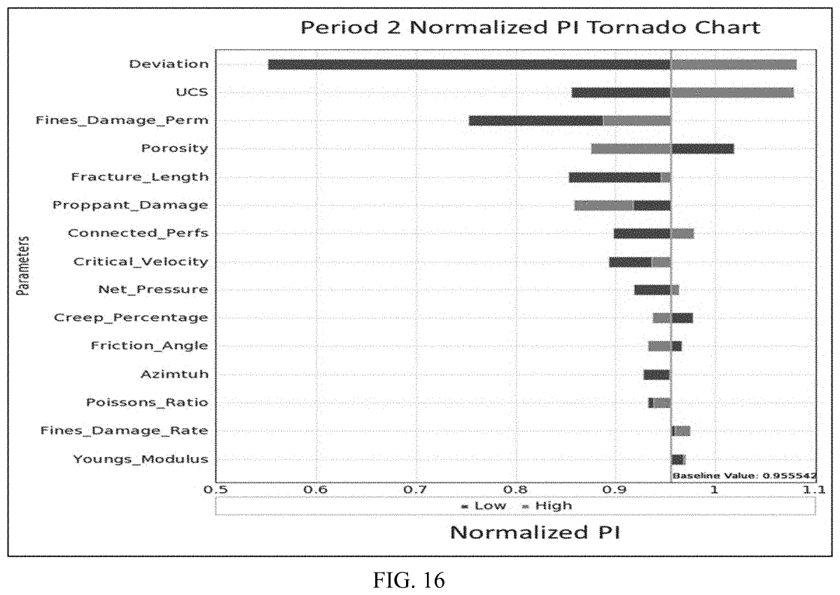

Period 2 (partial perforation tunnel collapse) follows on from the first period and its beginning is defined by the point at which the total borehole depletion causes the perforation tunnels to start to collapse. As explained previously, this is a function of the rock strength (UCS) and elastic properties (Poisson's Ratio, Biot's Constant and Young's Modulus). The decline rate during this period is defined by the well deviation relative to the stress field and the variation of UCS across the completed interval. The period end is defined by the point at which all the unpropped perforation tunnels collapse and only the connected and supported perforations remain. A tornado chart representative of the change in PI from the initial state is included in FIG. 16.

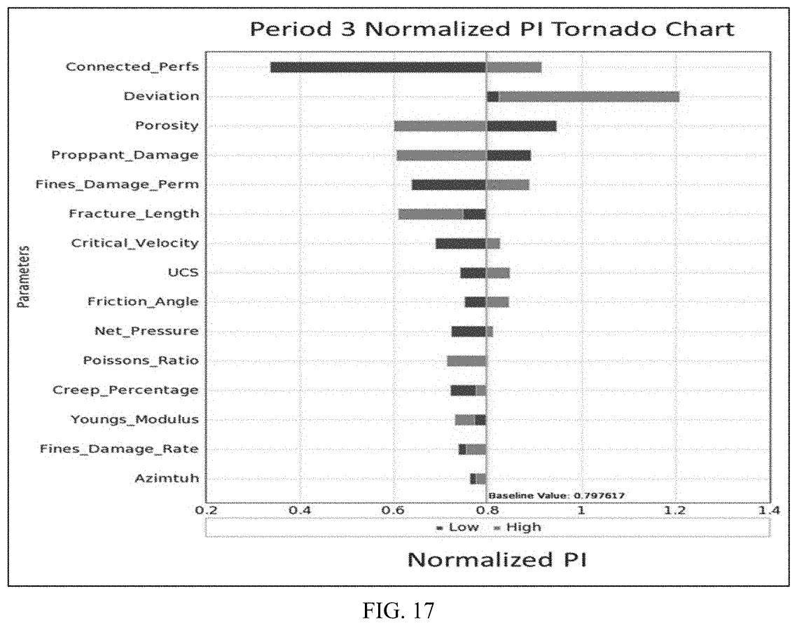

The final period, period 3 (post perforation tunnel collapse), start is defined by the point at which all the unpropped perforation tunnels collapse and only the connected and supported perforations remain. The decline rate is defined by fines migration related parameters (Fines Damage Permeability, Proppant Damage and Fines Damage Rate). FIG. 17 shows the tornado chart associated with period 3. In this sense the first and third period can be categorized by a similar performance with the second period acting as a transition from a pre-failure to a post-failure state. The decline trends in period 1 and 3 are similar with the difference of inflow area that is reduced over period 2. The decline rate in period 2 is much more significant and detrimental.

The behavior changes from period 1 to 2 to 3 occur due to the combination of the initial stress state (low effective stress) and the large intended depletion that is applied to an intermediate strength rock. If the rock was weaker as is typical of an unconsolidated asset, then the production would skip periods 1 and 2 and initiate in post failure environment. Additionally, if the asset is not over pressured or if assessment is being performed on an infill well where depletion has already occurred, the performance would also mimic period 3.

Conclusion of Example A: Through the development of the workflow of Example A and the assessment of a specific asset class, several conclusions on the performance of the asset class can be reached. Regarding the formation characteristics of the asset class, it is categorized by intermediate strength rock, elevated pore pressure and high formation permeability.

The elevated pore pressure means that although the formation is deep with a large overburden stress the effective stress on the rock is low. Combining this with the intermediate rock strength of the formation indicates that rock failure and specifically perforation tunnel collapse is not expected at initial conditions. This also means that with significant depletion the rock undergoes an increase in the effective stress to the point of rock failure and perforation tunnel collapse. It is during this period that the productivity of the well under a poor initial completion will suffer substantially. In cases where the rock strength is low, where the initial pore pressure is low or when completing in a depleted reservoir it is likely that the rock would fail during the initial completion and that the perforations are likely to collapse during the completion process. In these cases, the completions are likely to have a halo of proppant around the wellbore due to borehole expansion as part of the proppant placement. It is also likely that the substantial PI decline would not be observed, and the initial completion quality would control the performance of the well. Effectively these completions would behave as if in period 3.

The high permeability of the rock means that the off-plane perforations that collapse were contributing a substantial proportion of the production. In lower permeability reservoir the off-plane perforations are also likely to collapse when undergoing the same depletion process however their initial contribution would have been insubstantial and would therefore not significantly impact the well productivity.

To assess whether the performance of a given field with the highlighted formation characteristics is susceptible to significant PI decline the following steps can be taken: (1) Perform a rock strength test to assess the sanding envelope; (2) Assess whether you are above or below the sanding envelope under initial conditions; (3) Assess whether you will cross the sanding envelope with depletion; (4) Potential for significant declines occurs as the formation moves across the sanding envelope; (5) Assess the extent of fines migration from the extended fines migration test; and/or (6) Assess completion quality, assure well connectivity and screen outs.

In combination with the perforation tunnel collapse the high flux under, which many of high flux wells operate (specifically in period 3), leaves them susceptible to extensive fines migration damage. Therefore, the two mechanisms that control the performance are perforation tunnel collapse and fines migration. Completion quality then becomes the governing factor to delineate poor performing wells from good performing wells.

Example B: An example, referred to Example B, is provided below. Information about Example B is also found in Li, Y., Zaki, K., Tan, Y., Wu, R., & Rijken, P. “Productivity Decline: Improved Production Forecasting Through Accurate Representation of Well Damage”, SPE Annual Technical Conference and Exhibition, Calgary, Alberta, Canada, 30 Sep.-2 Oct. 2019: SPE 196213-MS, which is incorporated by reference.

PI (Productivity Index) degradation is a common issue in many oil fields. To obtain a highly reliable production forecast, it is critical to include well and completion performance in the analysis. A workflow of Example B is developed to assess and incorporate the damage mechanisms at the wellbore, fracture and reservoir into production forecasting. Currently, most reservoir models use a skin factor to represent the combined well damages mechanisms. The skin factor is adjusted based on the user's experience or data analysis instead of physical modeling. In this workflow of Example B, a detailed model is built to explicitly simulate the damage mechanisms, assess the dynamic performance of the well and completion with depletion, and generate a physics-based proxy function for reservoir modeling. The workflow of Example B closes the modeling gap in production forecasting and provides insights into which damage mechanisms impact PI degradation.

In the workflow of Example B, a detailed model is built, which includes an explicit wellbore, an explicit fracture and the reservoir. Subsurface rock and flow damage mechanisms are represented explicitly in the model. Running the model with an optimization tool, the damage mechanisms' impact on productivity can be assessed separately or in a combination. A physics-based proxy is generated linking the change in productivity to typical well parameters such as cumulative production, drainage region depletion and drawdown. This proxy is then incorporated into a standard reservoir simulator through the utilization of scripts linking the PI evolution of the well to the typical well parameters stated above. The workflow of Example B increases the reliability of generated production forecasts by incorporating the best representation of the near wellbore flow patterns.

By varying the damage mechanism inputs, the workflow of Example B is capable of history matching and forecasting the observed field behavior. The workflow of Example B has been validated for a high permeability, over pressured deep-water reservoir. The history match, PI prediction and damage mechanism analysis are presented in this disclosure. The workflow of Example B can help assets to: (1) history match and forecast well performance under varying operating conditions; (2) identify the key damage mechanisms which allows for potential mitigation and remediation solutions; and (3) set operational limits that reduce the likelihood of future PI degradation and maintain current performance.

Example B—Introduction: PI degradation has been observed in many reservoirs. Causes of PI decline stem from different field development phases, such as drilling, completion, production, stimulation, remediation, etc. There have been many efforts in oil/gas industry to identify the damage mechanisms behind PI degradation. This Example B focuses on seven damage mechanisms: 1) Off-plane perforation contribution and stability, 2) Fracture connectivity and tortuosity, 3) Drilling and completion fluids invasion, 4) Creep and compaction effects, 5) Fracture conductivity, 6) Fines migration and trapping, and 7) Non-Darcy flow effects. FIG. 4 lists the damage mechanisms and related variables by Zaki, K., Li, Y., & Terry, C. “Assessing the Impact of Open Hole Gravel Pack Completions to Remediate the Observed Productivity Decline in Cased Hole FracPack Completions in Deepwater Gulf of Mexico Fields”, SPE Annual Technical Conference and Exhibition, Dallas, Tex., USA, 24-26 Sep. 2018: SPE 191731-MS, which is incorporated by reference.

Accurately incorporating PI degradation and related damage mechanisms into reservoir simulation has a big impact on production forecasting. In reservoir simulation, skin or PI multiplier are used to represent near well and fracture damages. Normally the skin or PI multiplier is developed through decline curve analysis or data-based estimation. This type of skin or PI multipliers may be able to represent the historical events within the valid data range, but future events or potential changes cannot be represented through extrapolation. Incorporating the physics behind PI degradation is key for reliable prediction. Capturing the full physics in the PI multiplier or skin not only can result in better field forecasts but also can predict which potential damage mechanisms dominate in the different production phases. In this Example B, a PI decline prediction workflow is introduced which explicitly models physical mechanisms near the well and fracture, history matches field data, and builds a physics-based PI proxy which is implemented in the reservoir simulator for production forecasting and operational decisions.

The workflow of Example B provides the link between reservoir production forecasting and near well damage mechanisms. A sector model is built with a detailed completion geometry to simulate near well fluid and geomechanics damage mechanisms. Using boundary conditions extracted from the reservoir model and well conditions from field data, the sector model can simulate field events and history match field data. Using the proxy function generated from the detailed sector model, the reservoir model can represent the well and formation damage mechanisms successfully.

Example B is divided into five sections. After the introduction, the second section will introduce the detailed model. The model explicitly represents the completion geometry and can model complex fluid and rock behavior near the well and fracture. In the third section, the workflow detail is presented. The workflow of Example B includes: 1) DOE matrix, 2) history match, 3) prediction, and 4) proxy generation. Using the history matched model, engineers can determine the dominant damage mechanisms and make plans for remediation. The fourth section is devoted to the workflow application in a high perm high pressured reservoir. In the last section, a summary is provided.

Example B—Model description: A detailed model is built to accurately capture the near wellbore completion geometry, complex fluid flow and rock behavior. A fully-coupled flow and geomechanics model used to simulate various damage mechanisms during production. The seven damage mechanisms mentioned in the introduction section of Example B can be simulated separately or in any different combination. Simulating the damage mechanism explicitly ensures the model has both history-matching and predictive capability.

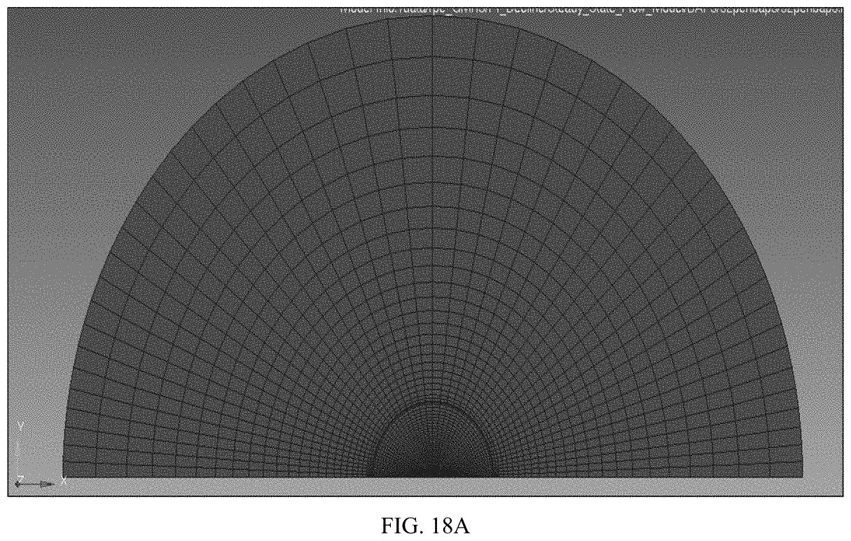

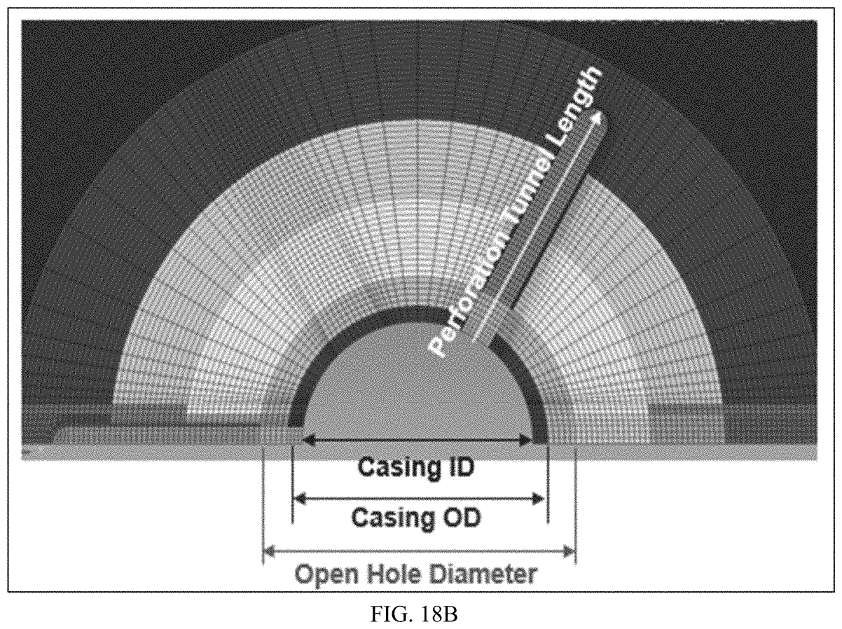

FIG. 18A-18B illustrate a sector model and the detailed wellbore geometry. The size of the sector model is determined by the drainage region. As the model will history match PTA (pressure transient analysis) data, the model needs to represent the same flow region as the PTA analysis. To include the wellbore details, the mesh size can be as small as 0.5 inch. The model size would be extremely large if one were to use this mesh to build a hundred feet thick model. To reduce the number of cells and reduce the computational cost, a 5 feet thick model was used. The 5 feet model shown in FIGS. 18A-18B has a radius of 600 ft. This small model already has 2,000,000 cells. In the 5 feet model, averaged reservoir and rock properties were used. It can effectively represent averaged reservoir behavior and history match PTA data which shows the averaged response from entire drainage zone.

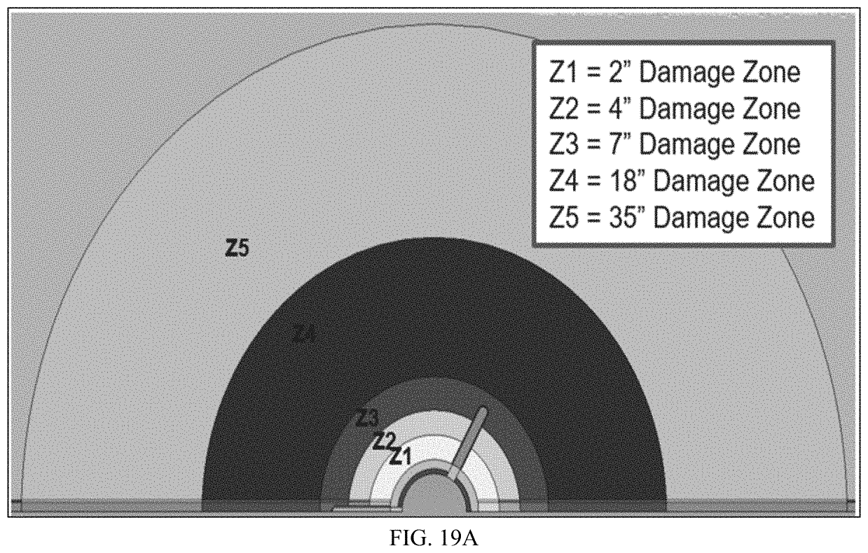

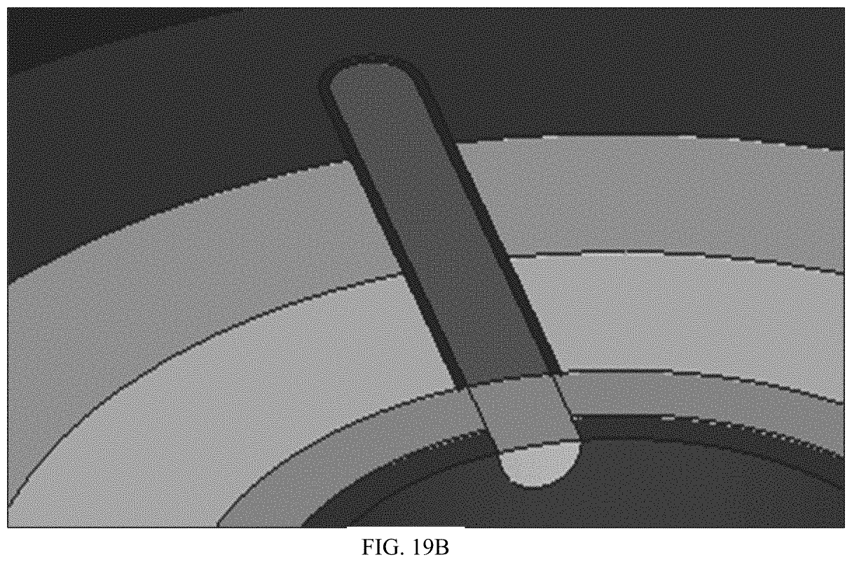

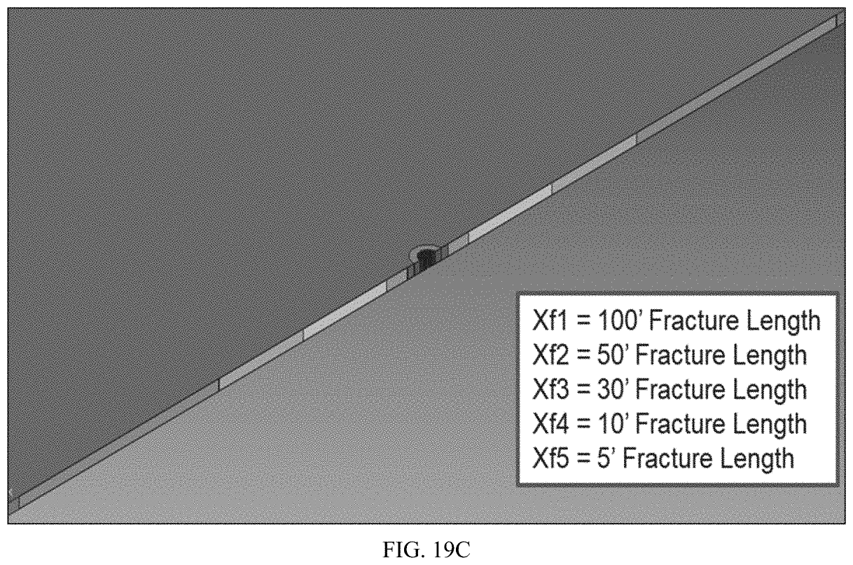

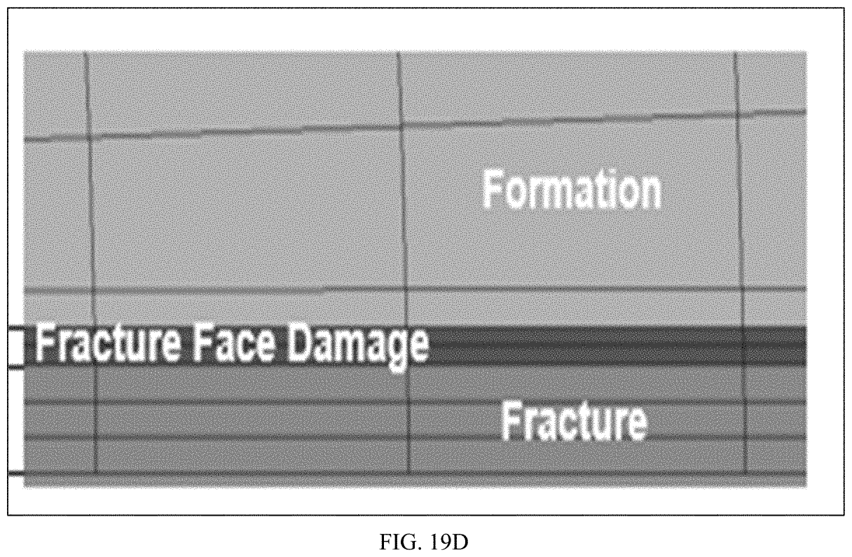

The damage zones are shown in FIGS. 19A-19D. FIG. 19A illustrates five damage zones near the wellbore. In these zones, damage related to drilling/completion fluid invasion, fines migration, compaction, and perforation collapse, are captured. FIG. 19B shows the perforation tunnel and the damage zone around the perforation face. In this area, turbulent flow, perforation collapse and fines migration are the possible damage mechanisms. FIG. 19C shows how different fracture lengths are included in the model. Fracture connectivity, tortuosity, and fracture conductivity loss are the damage mechanisms captured in these regions. FIG. 19D shows the damage zone around the fracture face. Fines migration and proppant embedment are the damage mechanisms captured in these regions. In the reservoir, compaction and creep are represented. Overall, the model can include all damage mechanisms near the well, perforation and fracture, and in the reservoir.

Compared to a simplified line source well model, the detailed model of Example B has two advantages. First, by modifying material properties in each component, the user can use the model to simulate production for different completions, like open hole gravel pack, open hole fracpack, cased hole fracpack, etc. Secondly, with these components included, the model of Example B can simulate production subject to different damage mechanisms independently and explicitly instead of using empirical correlations.

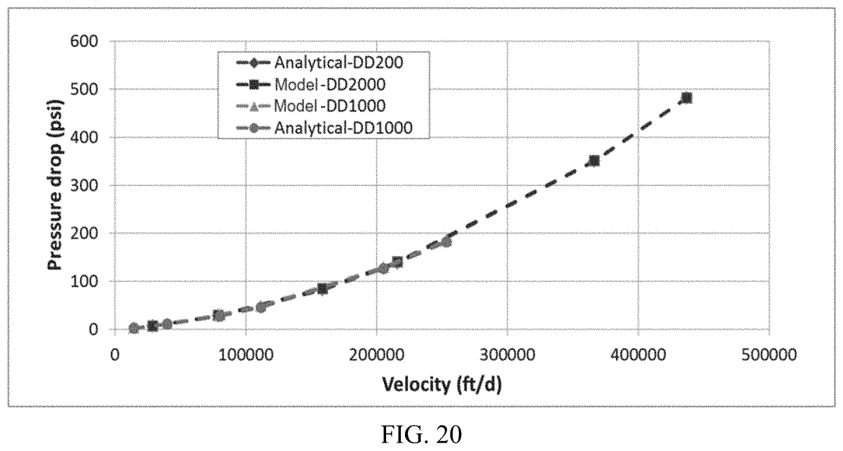

Example B—Model Validation: The detailed model of Example B is validated with analytical solutions for three types of completions: 1) open hole, 2) fractured, and 3) cased hole wells. For the open hole completion, the model of Example B is validated against the analytical radial flow solution. For the open hole fracpack completion, the model of Example B is validated against a semi-analytical solution by Cinco-Ley, H., & Samaniego-V., F. Transient Pressure Analysis: Finite Conductivity Fracture Case Versus Damaged Fracture Case, in SPE Annual Technology Conference and Exhibition San Antonio, Tex. USA, 5-7 Oct. 1981: 10179-MS, which is incorporated by reference. For the cased hole completion, the model of Example B is validated against an analytical solution by Burton, C., Rester, S. Davis, E. Comparison of Numerical and Analytical Inflow Performance Modeling of Gravel packed and FracPacked Wells, in SPE Formation Damage Control Symposium Lafayette, La., USA, 14 Feb. 1998: 31102-MS, which is incorporated by reference. Tables 1A and 1B show that for open hole and fracpack wells, the error between the model and the analytical solution is less than 1%. FIG. 20 shows that pressure and velocity match the analytical solution for a cased hole fracpack.

TABLE 1A

| Open hole | Rate (bpd) | Error |
|---|---|---|
| Analytical solution [radial flow] | 27.22 | |
| Detailed model | 27.06 | −0.58% |

TABLE 1B

| Frac pack | Rate (bpd) | Error |
|---|---|---|
| Semi-analytical solution [Cinco-Ley, 1981] | 46.8 | |
| Detailed model | 47.1 | 0.60% |

Example B—PI Decline Prediction Workflow: The goal of the workflow of Example B is to integrate near well damage into field-scale reservoir simulation. In this workflow of Example B, a proxy function is generated from a detailed model and implemented into a reservoir simulator. Reservoir engineer can use this physics-based PI proxy to obtain a reliable production forecast rather than using analog based estimation or empirical correlations.

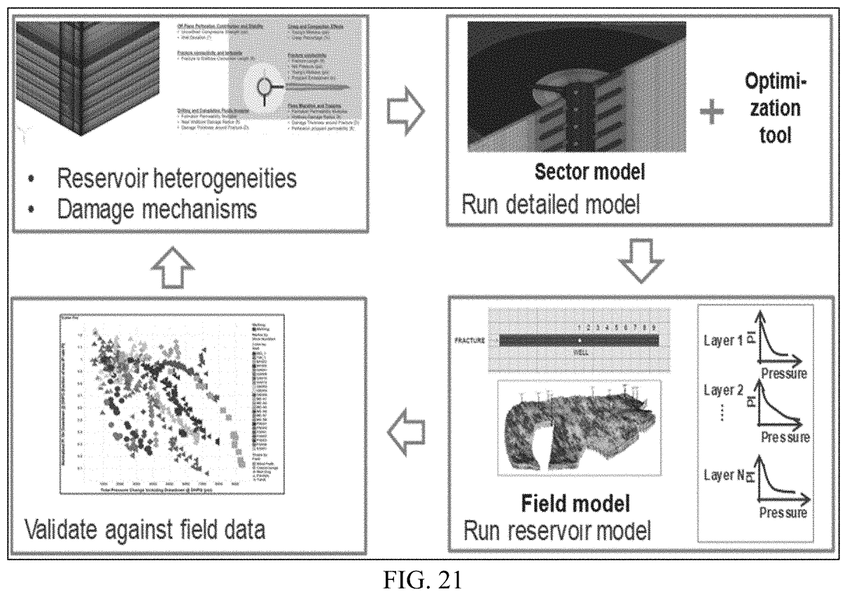

A flow chart of the workflow of Example B is shown in FIG. 21. The upper left inset in FIG. 21 shows the uncertainties from the different sources (reservoir heterogeneities and damage mechanisms). These uncertainties are represented in DOE through different variables. The upper right inset in FIG. 21 shows that the detailed sector model is linked with an optimization tool, through which one can automatically history match production data. The bottom right image of FIG. 21 shows a PI multiplier proxy that is generated and implemented into the reservoir simulator. The proxy can change for different zones. The bottom left is to compare field data with the reservoir simulation results. If the simulation result is not consistent with field observations, the steps may be reviewed and iterated over. Next, the details of the workflow of Example B are discussed: the DOE matrix, history match and prediction, and proxy generation.

Example B—DOE matrix: Through DOE, the model of Example B can model different damage mechanisms. Variables in the DOE are the following: lab test data, well completion data, reservoir properties, rock properties, and field operational data. Each of the variables is related with one or several damage mechanisms. Before building the DOE matrix, it may be useful to discuss with the asset team the potential damage mechanisms and decide on the possible variables. This discussion may include representation from reservoir, production, completion and drilling to ensure the variables and variable ranges are captured appropriately.

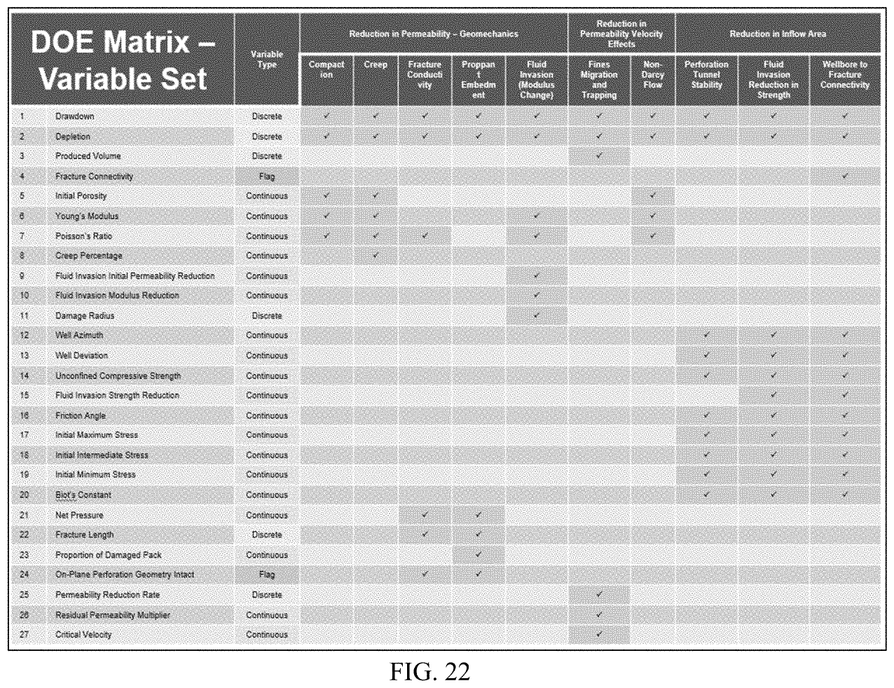

The relation between the DOE variables and damage mechanisms are modeled or calculated analytically in the workflow of Example B. One damage mechanism can be triggered by different events. FIG. 22 shows an example of the DOE for a high permeability reservoir. The DOE lists all possible relations between variables and damage mechanisms. For example, six variables are related with fines migration and trapping, e.g. drawdown, depletion, produced volume, permeability reduction rate, residual permeability, and critical velocity. Critical velocity, permeability reduction rate and residual permeability are extracted from extended fines migration tests by Tan, Y., Li, Y., Wu, R., Rijken, P., Zaki, K., Karazincir, O., Williams, W., Wang, B. “Modeling of Production Decline Caused by Fines Migration in Deep Water Reservoirs”, in SPE Annual Technical Conference and Exhibition, San Antonio, Tex., USA, 9-11 Oct. 2017: SPE 187263-MS, which is incorporated by reference. They are more related with rock type and fluid type. Drawdown, depletion and produced volume are obtained from field data. Higher drawdown induces higher fluid velocity, hence more fines will be mobilized and plug the formation. Depletion and produced volume are time-dependent variables, which determine the accumulation of trapped fines. Variables related with all the seven damage mechanisms are included in FIG. 22.

Example B—History match and prediction: The detailed model of Example B is developed using a Chevron in-house simulator, GMRS™ (Geomechanical Reservoir Simulator). GMRS can model coupled flow and geomechanics, an explicit wellbore, permeability and porosity damages, turbulent flow, etc. All damage mechanisms illustrated in FIG. 4 can be represented in the GMRS model. The model is linked with a Chevron's in-house optimization tool, which has automatic workflow for history matching and uncertainty analysis making the history match and prediction more efficient. However, commercially available simulators and/or optimization tools may be utilized in some embodiments. For example, a commercially available geomechanical simulator or a simulator capable of simulating geomechanics and flow may be utilized. For example, a commercially available tool, such as spreadsheet software, may be used for DOE to find a solution surface for history matching.

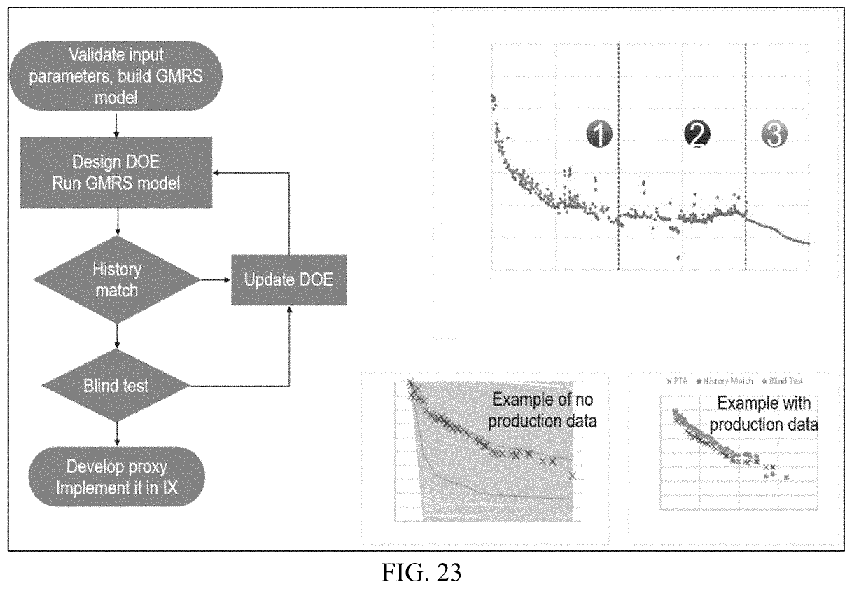

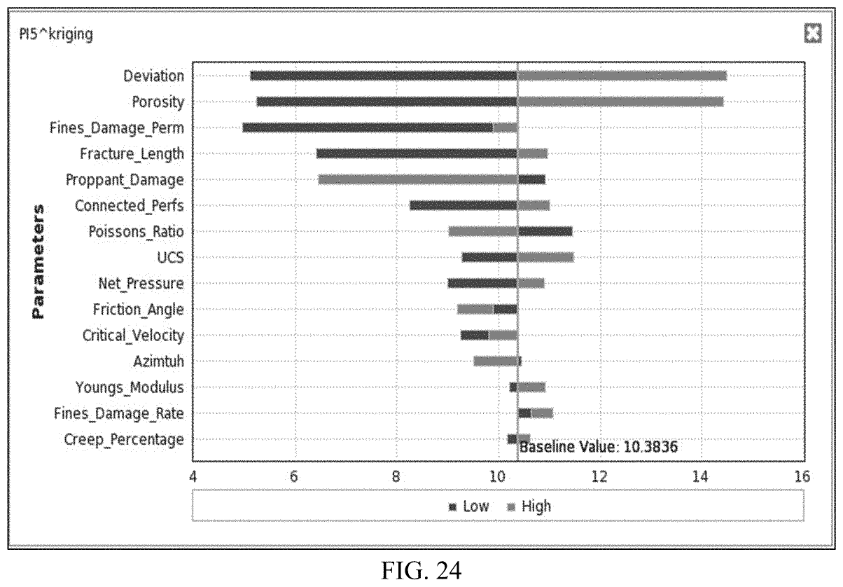

The history match and prediction part happens in three steps: 1) history match, 2) blind test, and 3) prediction. FIG. 23 shows the history match workflow of Example B. The first step is the proxy-assisted history match using partial of field data. Due to the large number of input variables and the detailed flow and geomechanics model, history matching can take significant high computational time. Hence, a proxy may be used to reduce the computational time for history matching. After generating the DOE and running the detailed model, a response surface is generated for history matching. Once the proxy matches the history data, the detailed model is rerun to replicate the proxy history matched results. This is performed because of the high nonlinearity between the input variables and the proxy function. The process then iterates if the history match results are not satisfactory. In that case, the DOE and model set up are reviewed and redesigned until the results successfully match the field data. Through history matching, the model has appropriate variables ranges and representative damage mechanisms. By analyzing inputs and results of the history matched model, one can understand which variables have bigger impact on productivity and which damage mechanisms are the dominant damage factors. FIG. 24 shows a Tornado plot for a high permeability reservoir at a later production period. Well deviation, formation porosity, fines migration, fracture length and off-plane perforation collapse are the dominant damage mechanisms. The Tornado plot is different for different production periods, which is discussed in Zaki, K, Li, Y, Tan, Y, Wu, R, Rijken, P, “Productivity Decline: The Underlying Geomechanics and Contributing Damage Factors”, SPE Annual Technical Conference and Exhibition, Calgary, Alberta, Canada, 30 Sep.-2 Oct. 2019: SPE-196223-MS, which is incorporated by reference.

The second step is the blind test. This may include running the history matched model and comparing it with additional field data. If the model results match the field data, then the third step can begin. If not, the DOE, model and history match proxies are reviewed and history match step is repeated. The model is not validated unless it passes the blind test.

Third step is prediction. In this step, the model can be run with different operational constraints, stimulations or other remediation strategies. It can help the asset team to make decisions to optimize production.

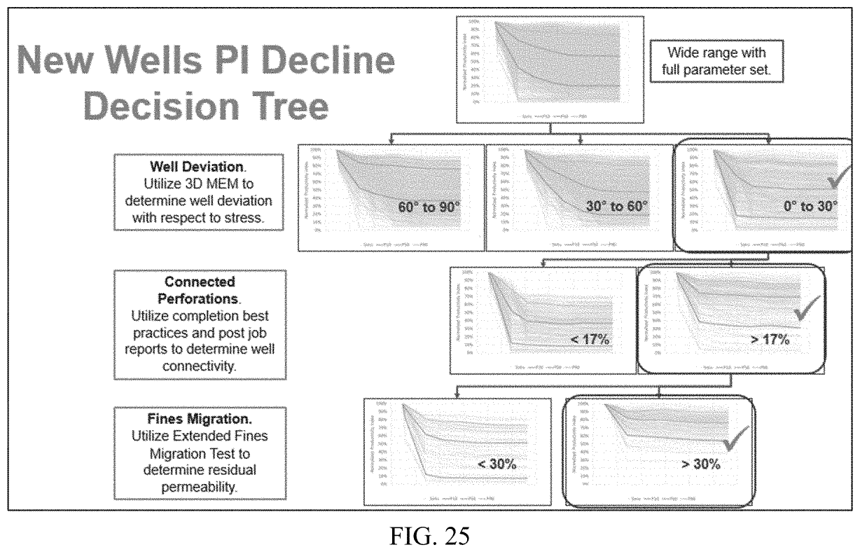

For new wells without production data, the workflow of Example B can provide PI estimation based on well and reservoir properties. By categorizing and narrowing down the input variables range, the model can provide P10, P50, P90 PI trends. FIG. 25 shows a decision tree for a new well. Using the decision tree, one can reduce uncertainties in the PI trend.

Example B—Proxy Generation: The predicted PI trend from the history matched model is exported as a proxy function applied to the PI multiplier in the reservoir simulator. Depending on the user's preference, the PI multiplier proxy function can be simple (including fewer variables) or more complex (including more variables). The most common variables used in PI degradation are reservoir depletion, drawdown and cumulative production. A proxy function with these three variables is the basic format. Depending on the reservoir, the completion type, or if high accuracy is requested, more parameters can be used in the proxy. For a hydraulically fractured well in a low permeability reservoir, depletion may not be available, so borehole depletion or borehole flowing pressure, and initial reservoir pressure can be used in the proxy. Fracture length, fracture width, and proppant permeability also can be used.

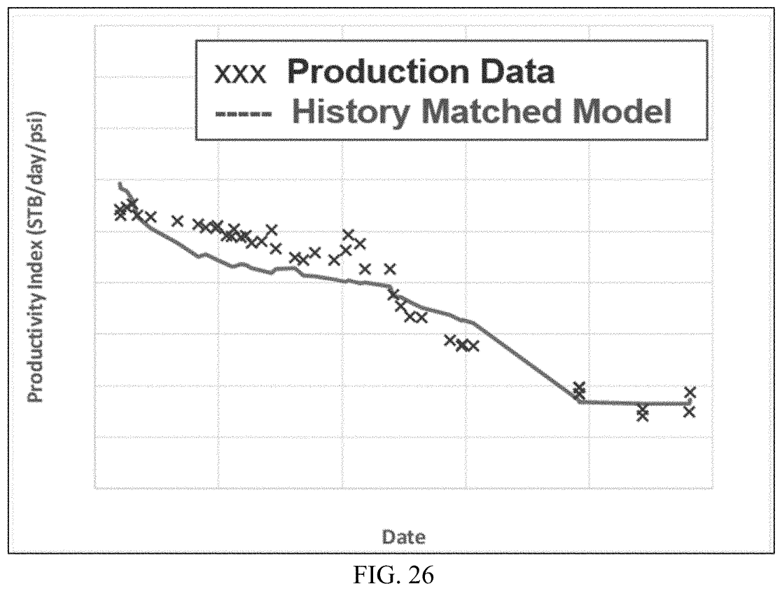

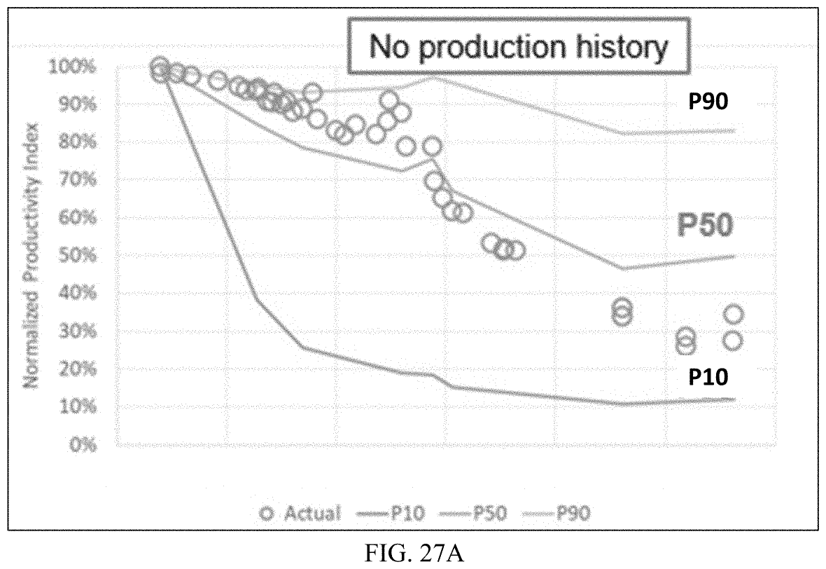

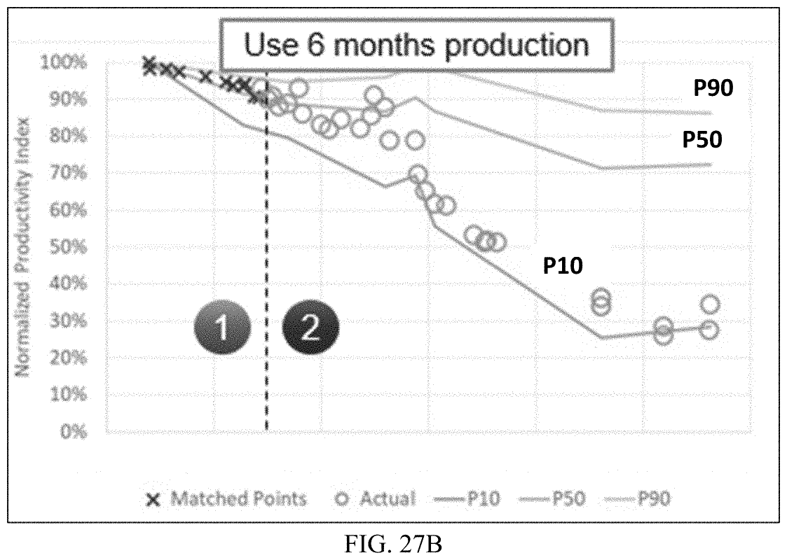

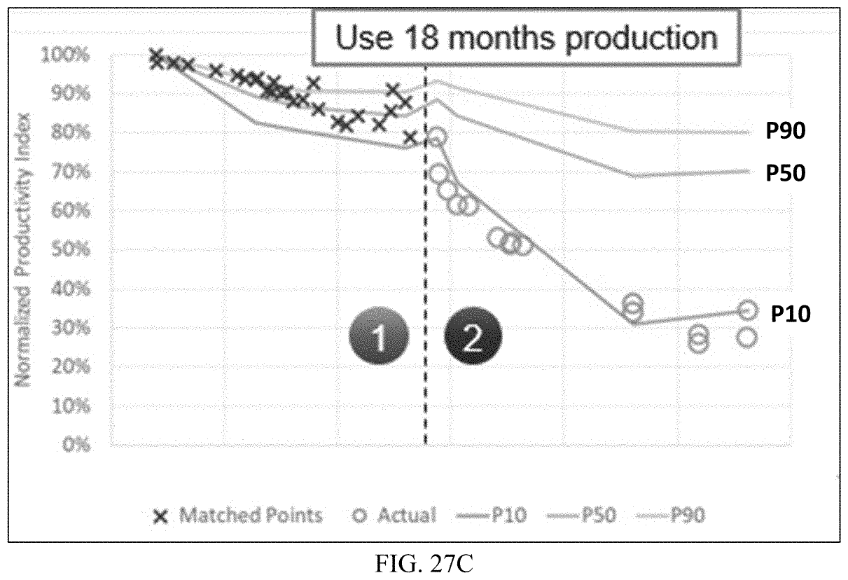

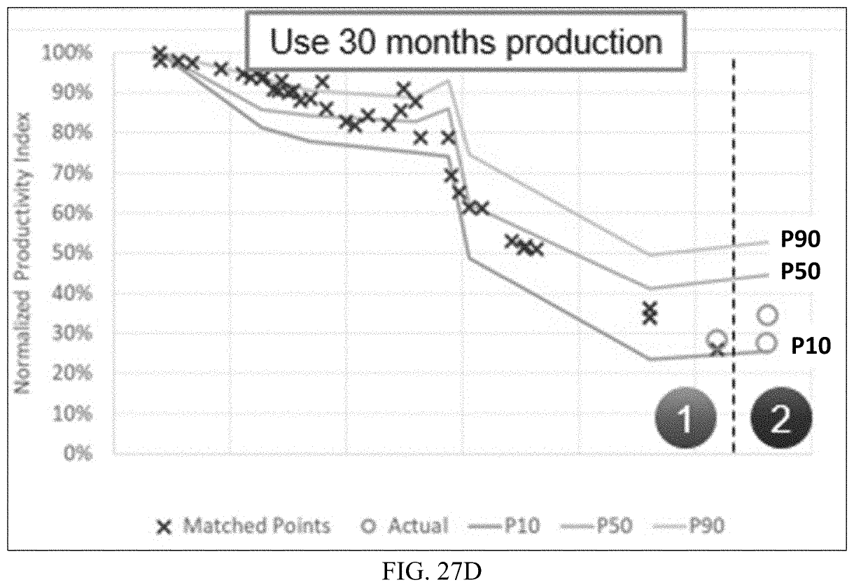

Example B—Field application: The workflow of Example B has been applied to a high perm and over-pressured reservoir A. In this reservoir, initial PI decline trend was estimated using analog field data. But after production commenced, the PI decline was worse than expected. Hence the business unit wanted to: 1) understand the potential reservoir differences, 2) identify any potential damage mechanisms, and 3) obtain a reliable PI trend. The PI decline prediction workflow of Example B was used identify the damage mechanisms, identify the big hitters for PI degradation and provide a proxy function to be used in the reservoir simulator. A 5-feet model was built and run through the workflow of Example B. The workflow of Example B successfully history matched field data and the result is shown in FIG. 26. FIG. 27A-27D shows the predictive capability of the model of Example B. Using partial production data, the model of Example B can history match and provide a PI range. If more data is used, more accurate PI ranges and trends are obtained. More detailed of the damage analysis can be found in Zaki, K, Li, Y, Tan, Y, Wu, R, Rijken, P, “Productivity Decline: The Underlying Geomechanics and Contributing Damage Factors”, SPE Annual Technical Conference and Exhibition, Calgary, Alberta, Canada, 30 Sep.-2 Oct. 2019: SPE-196223-MS, which is incorporated by reference.

After history matching, a proxy is generated and implemented into the reservoir model. The proxy is a function of depletion, drawdown and cumulative produced volume. The productivity prediction using the reservoir model with PI proxy is shown. The original reservoir model uses skin to history match well production. The skin value is one variable in history matching, tuned with time. To use the PI proxy in the reservoir model, first, define the drainage zone, DP (depletion), DD (draw down) and PV (produced volume). For field A, a high perm reservoir, the radial flow equation was used to calculate the radius of the drainage zone. In the drainage zone, the following variables were defined:

DP=P*−P*₀, DD=P*−P_{w}, PV=∫ₜ Q Equation 1

where,

P*—current drainage area average pressure,

P*₀—initial drainage area drainage pressure,

P_{w}—wellbore flowing pressure, and Q—flow rate.

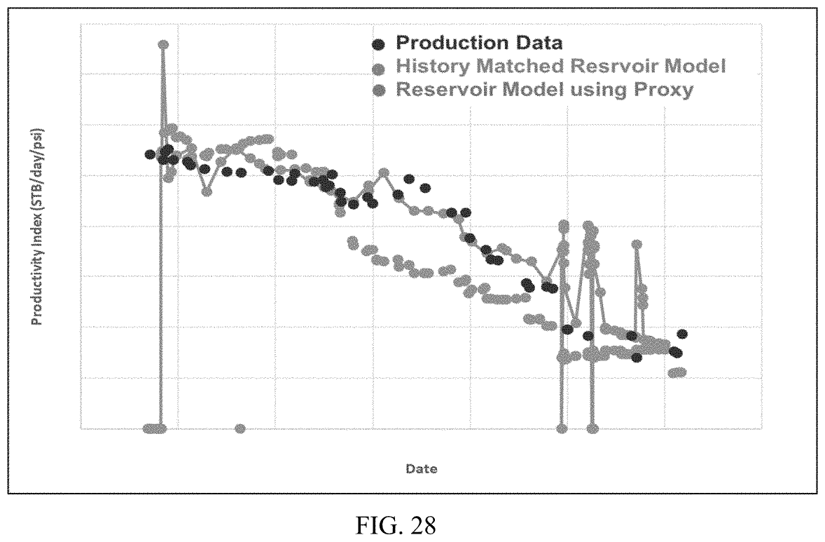

Next, delete all the skin from the reservoir model and implement the proxy function. At each time step, the reservoir simulator extracts DP, DD, PV from the defined drainage zone, calculates PI multiplier and production. FIG. 28 shows the comparison between the production data, results of history matched reservoir model (using the PI decline trend for analog fields), and results of reservoir model using the new PI proxy. The model using the proxy function provides same PI trend as the production data. The benefit of having this more rigorous history match and forecast is that the asset team, through the analysis, has a better understanding of which factors are impacting their PI decline trend and what they can do to mitigate excessive decline.

Example B—Summary: API decline prediction workflow was introduced. The workflow of Example B identifies near well and fracture damage mechanisms and implements the damage mechanisms into a field-scale reservoir simulation through a proxy function. Utilizing the workflow, the user is able to: 1) obtain better PI forecasts, and 2) identify and remediate the most significant damage mechanisms impacting the fields PI trend.

Seven damage mechanisms are addressed in the workflow of Example B: 1) off-plane perforation contribution and stability, 2) Fracture connectivity and tortuosity, 3) Drilling and completion fluids invasion, 4) Creep and compaction effects, 5) Fracture conductivity, 6) Fines migration and trapping, and 7) Non-Darcy flow effects.

A detailed sector model is used to model the above-mentioned damage mechanisms. The model represents the completion geometry and damage zones at the well, perforation and fracture. It models damage mechanisms independently or in any combination. Using DOE, the model can history match production data and generate PI forecasts. Through analysis of the inputs and results of the history matched model, the dominant damage mechanisms and most impactful variables over the life of the field may be identified. The proxy function is generated from the history matched model. It represents the physics in the near wellbore region and in and around the fracture. Using the proxy function, the reservoir model provides a more reliable and accurate production forecast. The workflow of Example B is applied to a high perm reservoir. The results show the reservoir model successfully matches production data by using the proxy function. The workflow of Example B also can be used for new well PI trend estimation by using a decision tree to reduce uncertainties in PI prediction.

References: The following references are each incorporated by reference: (a) Bejan, A. (1984). Convection Heat Transfer. John Wiley & Sons.; (b) Burton, C., Rester, S. Davis, E. Comparison of Numerical and Analytical Inflow Performance Modeling of Gravel packed and FracPacked Wells, in SPE Formation Damage Control Symposium Lafayette, La., USA, 14 Feb. 1998: 31102-MS.; (c) Burton, R. C. “Use of Perforation-Tunnel Permeability to Assess Cased Hole Gravel pack Performance.” Society of Petroleum Engineers Dec. 1, 1999: 59558-PA; (d) Chen, Economides (1999). Effect of Near-Wellbore Fracture Geometry on Fracture Execution and Post-Treatment Well Production of Deviated and Horizontal Wells, in SPE Production & Facilities. Volume 14, Number 3, 177-186. SPE 57388-PA.; (e) Cinco-Ley, H., & Samaniego-V., F. Transient Pressure Analysis: Finite Conductivity Fracture Case Versus Damaged Fracture Case, in SPE Annual Technology Conference and Exhibition San Antonio, Tex. USA, 5-7 Oct. 1981: 10179-MS.; (f) Cleary, Johnson, Kogsboll, Owens, Perry, de Pater, Stachel, Schmidt, Tambini (1993). Field Implementation of Proppant Slugs to Avoid Premature Screen-Out of Hydraulic Fractures with Adequate Proppant Concentration, in Low Permeability Reservoirs Symposium, 26-28 Apr. 1993, Denver, Colo. SPE 25892-MS.; (g) Ewy, Ray, Bovberg, Norman, Goodman (1999). Openhole Stability and Sanding Predictions by 3D Extrapolation from Hole Collapse Tests, in SPE Annual Technical Conference and Exhibition, Houston, Tex., USA, 3-6 Oct. 1999: SPE 56592-MS.; (h) Hodge, R. M., Burton, R. C., Fischer, C. C., & Constien, V. G. “Productivity Impairment of Openhole Gravel Packs Caused by Drilling-Fluid Filter Cake”, in SPE International Symposium and Exhibition on Formation Damage Control Lafayette, La., USA, 10-12 Feb. 2010: SPE 128060-MS.; (i) Karazincir, O., Li, Y., Zaki, K., Williams, W., Tan, Y., Wu, R., Rijken, P., Rickards, A. “Measurement of Reduced Permeability at Fracture Face Due to Proppant Embedment and Depletion”, in SPE Annual Technical Conference and Exhibition, Dallas, Tex., USA, 24-26 Sep. 2018: SPE 191653-MS.; (j) Karazincir, O., Williams, W., & Rijken, P. (2017, Oct. 9). “Prediction of Fines Migration through Core Testing. Society of Petroleum Engineers”, in SPE Annual Technical Conference and Exhibition, San Antonio, Tex., USA, 9-11 Oct. 2017: SPE 187157-MS.; (k) Knobles, M., Blake, K. J., Fuller, M. J., & Zaki, K. “Best Practices for Sustained Well Productivity: A Lookback in to Deepwater FracPack Completions”, in SPE Annual Technical Conference and Exhibition, San Antonio, Tex., USA, 9-11 Oct. 2017: SPE 187353-MS.; (l) Li, Y., Zaki, K., Tan, Y., Wu, R., & Rijken, P. “Productivity Decline: Improved Production Forecasting Through Accurate Representation of Well Damage”, SPE Annual Technical Conference and Exhibition, Calgary, Alberta, Canada, 30 Sep.-2 Oct. 2019: SPE 196213-MS.; (m) Marquez, M., Williams, W., Knobles, M., Bedrikovetsky, P., & You, Z. (2013, Jun. 5). “Fines Migration in Fractured Wells: Integrating Modeling, Field and Laboratory Data”, in SPE European Formation Damage Conference and Exhibition, Noordwijk, The Netherlands, 5-7 Jun. 2013: 165108-MS.; (n) Tan, Y., Li, Y., Wu, R., Rijken, P., Zaki, K., Karazincir, O., Williams, W., Wang, B. “Modeling of Production Decline Caused by Fines Migration in Deep Water Reservoirs”, in SPE Annual Technical Conference and Exhibition, San Antonio, Tex., USA, 9-11 Oct. 2017: SPE 187263-MS.; (o) Zaki, K., Li, Y., & Terry, C. “Assessing the Impact of Open Hole Gravel Pack Completions to Remediate the Observed Productivity Decline in Cased Hole FracPack Completions in Deepwater Gulf of Mexico Fields”, SPE Annual Technical Conference and Exhibition, Dallas, Tex., USA, 24-26 Sep. 2018: SPE 191731-MS.; and (p) Zaki, K, Li, Y, Tan, Y, Wu, R, Rijken, P, “Productivity Decline: The Underlying Geomechanics and Contributing Damage Factors”, SPE Annual Technical Conference and Exhibition, Calgary, Alberta, Canada, 30 Sep.-2 Oct. 2019: SPE-196223-MS.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method of evaluating production performance for a wellbore while accounting for subterranean reservoir geomechanics and wellbore completion, the method comprising:
generating a wellbore model defining a subterranean reservoir with a wellbore, wherein the subterranean reservoir comprises a near wellbore region and a far field region that is different than the near wellbore region, and wherein the wellbore comprises a wellbore completion;
defining geomechanical properties for the subterranean reservoir in the near wellbore region and the far field region, and completion variables for the wellbore completion; and
simulating fluid flow in the near wellbore region, the far field region, and the wellbore completion to evaluate production performance for the wellbore over a period of time, wherein a permeability of the subterranean reservoir and a contact area between the wellbore and the subterranean reservoir are updated during simulation over the period of time, wherein the permeability and the contact area are updated as a function of a change in pressure and the geomechanical properties for the subterranean reservoir in the near wellbore region and the far field region, the completion variables for the wellbore completion, or any combination thereof.

2. The method of claim 1, wherein the permeability and the contact area between the wellbore and the subterranean reservoir are updated based on a change in effective stress in the near wellbore region, the far field region, the completion, or any combination thereof.

3. The method of claim 1, wherein the permeability and the contact area between the wellbore and the subterranean reservoir are updated based on a change in a fluid flow velocity in the near wellbore region, the far field region, the completion, or any combination thereof.

4. The method of claim 1, wherein the permeability is updated based on a change in the contact area coupling the wellbore to the subterranean reservoir.

5. The method of claim 1, wherein the permeability and the contact area between the wellbore and the subterranean reservoir are updated based on one or more damage mechanisms in the near wellbore region, the far field region, the completion, or any combination thereof.

6. The method of claim 5, wherein the one or more damage mechanisms comprise fracture connectivity and tortuosity, fracture conductivity, fines migration and trapping, off plane perforation contribution and stability, creep and compaction, drilling and fluid completion damage, non-darcy fluid flow, or any combination thereof.

7. The method of claim 5, wherein a plurality of the damage mechanisms are simulated in conjunction with each other.

8. The method of claim 1, further comprising updating a compressibility of the subterranean reservoir during simulation over the period of time.

9. The method of claim 1, wherein the wellbore model further comprises at least one fracture geometry in the subterranean reservoir in the near wellbore region.

10. The method of claim 1, wherein the contact area between the wellbore and the subterranean reservoir is updated based on a fracture geometry in the subterranean reservoir in the near wellbore region, fines migration related parameters, or any combination thereof.

11. The method of claim 1, wherein evaluating production performance over the period of time further comprises generating a production forecast, evaluating productivity index (PI) decline for the wellbore, evaluating depletion for the wellbore, evaluating completion quality for the wellbore completion, optimizing a wellbore construction of the wellbore, optimizing the wellbore completion of the wellbore, or any combination thereof.

12. A system of evaluating production performance for a wellbore while accounting for subterranean reservoir geomechanics and wellbore completion, the system comprising:
a processor; and
a memory communicatively connected to the processor, the memory storing computer-executable instructions which, when executed by the processor, cause the processor to perform a method, the method comprising:
generating a wellbore model defining a subterranean reservoir with a wellbore, wherein the subterranean reservoir comprises a near wellbore region and a far field region that is different than the near wellbore region, and wherein the wellbore comprises a wellbore completion;
defining geomechanical properties for the subterranean reservoir in the near wellbore region and the far field region, and completion variables for the wellbore completion; and
simulating fluid flow in the near wellbore region, the far field region, and the wellbore completion to evaluate production performance for the wellbore over a period of time, wherein a permeability of the subterranean reservoir and a contact area between the wellbore and the subterranean reservoir are updated during simulation over the period of time, wherein the permeability and the contact area are updated as a function of a change in pressure and the geomechanical properties for the subterranean reservoir in the near wellbore region and the far field region, the completion variables for the wellbore completion, or any combination thereof.

13. The system of claim 12, wherein the permeability and the contact area between the wellbore and the subterranean reservoir are updated based on a change in effective stress in the near wellbore region, the far field region, the completion, or any combination thereof.

14. The system of claim 12, wherein the permeability and the contact area between the wellbore and the subterranean reservoir are updated based on a change in a fluid flow velocity in the near wellbore region, the far field region, the completion, or any combination thereof.

15. The system of claim 12, wherein the permeability is updated based on a change in the contact area coupling the wellbore to the subterranean reservoir.

16. The system of claim 12, wherein the permeability and the contact area between the wellbore and the subterranean reservoir are updated based on one or more damage mechanisms in the near wellbore region, the far field region, the completion, or any combination thereof.

17. The system of claim 16, wherein the one or more damage mechanisms comprise fracture connectivity and tortuosity, fracture conductivity, fines migration and trapping, off plane perforation contribution and stability, creep and compaction, drilling and fluid completion damage, non-darcy fluid flow, or any combination thereof.

18. The system of claim 16, wherein a plurality of the damage mechanisms are simulated in conjunction with each other.

19. The system of claim 12, wherein the computer-executable instructions, when executed, cause the processor to update a compressibility of the subterranean reservoir during simulation over the period of time.

20. The system of claim 12, wherein the wellbore model further comprises at least one fracture geometry in the subterranean reservoir in the near wellbore region.

21. The system of claim 12, wherein the contact area between the wellbore and the subterranean reservoir is updated based on a fracture geometry in the subterranean reservoir in the near wellbore region, fines migration related parameters, or any combination thereof.

22. The system of claim 12, wherein evaluating production performance over the period of time further comprises generating a production forecast, evaluating productivity index (PI) decline for the wellbore, evaluating depletion for the wellbore, evaluating completion quality for the wellbore completion, optimizing a wellbore construction of the wellbore, optimizing the wellbore completion of the wellbore, or any combination thereof.

23. A computer readable storage medium having computer-executable instructions stored thereon which, when executed by a processor, cause the processor to perform a method of evaluating production performance for a wellbore while accounting for subterranean reservoir geomechanics and wellbore completion, the method comprising:
generating a wellbore model defining a subterranean reservoir with a wellbore, wherein the subterranean reservoir comprises a near wellbore region and a far field region that is different than the near wellbore region, and wherein the wellbore comprises a wellbore completion;
defining geomechanical properties for the subterranean reservoir in the near wellbore region and the far field region, and completion variables for the wellbore completion; and
simulating fluid flow in the near wellbore region, the far field region, and the wellbore completion to evaluate production performance for the wellbore over a period of time, wherein a permeability of the subterranean reservoir and a contact area between the wellbore and the subterranean reservoir are updated during simulation over the period of time, wherein the permeability and the contact area are updated as a function of a change in pressure and the geomechanical properties for the subterranean reservoir in the near wellbore region and the far field region, the completion variables for the wellbore completion, or any combination thereof.
